(19) United States
(12) Patent Application Publication
(10) Pub. No.: US 2018/0218426 A1
(43) Pub. Date: Aug. 2, 2018

(54) SYSTEMS AND METHODS FOR PRIVACY PRESERVING RECOMMENDATION OF ITEMS

(71) Applicant: XEROX CORPORATION, Norwalk, CT (US)

(72) Inventors: Shailesh Vaya, Bangalore (IN); Aritra Dhar, Konnagar (IN); Theja Tulabandhula, Bangalore (IN)

(21) Appl. No.: 15/417,274

(22) Filed: Jan. 27, 2017

(51) Int. Cl. G06Q 30/06; G06F 17/30

(52) U.S. Cl. CPC G06Q 30/0631; G06F 17/30905; G06F 17/30867

(57) ABSTRACT

Methods and devices for privacy preserving recommendation of items based on association rules, each being represented as an antecedent that implies a consequent, are disclosed. The method includes receiving a transaction indicated by a query from a client device, where the transaction includes multiple items. The method further includes identifying association rules applicable to the transaction from a data structure storing a universal association rule set provided the association rules include antecedents that are a subset of the transaction. The association rules are identified based on a predefined criterion implemented using a predetermined rule fetch method. The method also includes determining consequents associated with the identified association rules, where each consequent includes an item, and collating a set of items based on the determined consequents. The method further includes recommending an item list from the collated set to the client device.

### TECHNICAL FIELD

The presently disclosed embodiments relate to oblivious transfer of data, and more particularly, to methods and systems for privacy-preserving item recommendations using association rules in a cloud environment.

### BACKGROUND

In recent years, e-commerce has boosted sales of products and services by bridging a disconnect between remote customers and vendors. Online users navigate through e-commerce portals to transact for desired items. Each transaction may include a purchased item and/or a set of chosen items, which are typically collated in a virtual shopping basket for future purchase. Such transaction is typically used to recommend new items for purchase based on association rules, which are usually mined from large databases storing a history of user purchase data and can be used for exploratory analysis as well as prediction and recommendation of new items. The association rules correlate an antecedent, for example, a user transaction, with a likely consequent such as a set of recommended items.

Item recommendations may be managed as a service on a cloud, where a server may receive different or same transactions as input from multiple sources, for example, multiple e-commerce portals. The server typically receives details of each new transaction (e.g., items in the virtual shopping basket) and selects association rules for that transaction from a list of association rules, which define correlation between different items maintained by the server. Since multiple association rules may apply to a given transaction, the server is required to select the most fitting association rules and swiftly provide the most relevant items for recommendation to the user.

Traditional approaches require such transaction data of the user to make item recommendations. The transaction data is a sensitive information that can be analyzed at the server or at a client device to profile each user through use of state-of-the-art machine learning techniques and to compute key information such as age, gender, income group, shopping habit, etc. about the user. Such information is extremely private to the user and often sold to advertisement agencies to send advertisements or may be used for other malicious activities.

Therefore, there exists a need for a robust recommendation system that enables a fast selection of applicable association rules and computes most relevant items for recommendations while preserving the privacy of (1) user's transaction data and (2) items stored in server's database.

### SUMMARY

One embodiment of the present disclosure includes a computer-implemented method for privacy preserving recommendation of items based on association rules. Each association rule is represented as an antecedent that implies a consequent. The method includes receiving a transaction indicated by a query from a client device. The transaction includes a plurality of items selected by a user. One or more association rules applicable to the received transaction are identified from a data structure storing a universal association rule set provided the one or more association rules include antecedents that are a subset of the transaction. The one or more association rules are identified based on one of a plurality of predefined criteria implemented using a predetermined rule fetch method. Further, consequents associated with the identified one or more association rules are determined. Each of the consequents include at least one item. Based on the determined consequents, a set of items is collated. The collated set of items is sorted based on a predefined attribute associated with each item in the set. From the collated set, a list of one or more items is recommended to the client device. A number of items in the list is based on a receiving capacity of the client device.

Another embodiment of the present disclosure includes a device for privacy preserving recommendation of items based on association rules. Each association rule is represented as an antecedent that implies a consequent. The device includes a rule fetch module and a recommendation module. The rule fetch module is configured to: receive a transaction indicated by a query from a client device, where the transaction includes a plurality of items selected by a user; identify one or more association rules applicable to the received transaction from a data structure storing a universal association rule set provided the one or more association rules include antecedents that are a subset of the transaction. The one or more association rules are identified based on one of a plurality of predefined criteria implemented using a predetermined rule fetch method. The rule fetch module is also configured to determine consequents associated with the identified one or more association rules, wherein each of the consequents include at least one item. The recommendation module is configured to collate a set of items based on the determined consequents. The collated set of items is sorted based on a predefined attribute associated with each item in the set. The recommendation module is also configured to recommend a list of one or more items from the collated set to the client device, wherein a number of items in the list is based on a receiving capacity of the client device.

Yet another embodiment of the present disclosure includes a non-transitory computer-readable medium comprising computer-executable instructions for privacy preserving recommendation of items based on association rules. Each association rule is represented as an antecedent that implies a consequent. The non-transitory computer-readable medium comprising instructions for receiving a transaction indicated by a query from a client device. The transaction includes a plurality of items selected by a user. One or more association rules applicable to the received transaction are identified from a data structure storing a universal association rule set provided the one or more association rules include antecedents that are a subset of the transaction. The one or more association rules are identified based on one of a plurality of predefined criteria implemented using a predetermined rule fetch method. Further, consequents associated with the identified one or more association rules are determined. Each of the consequents include at least one item. Based on the determined consequents, a set of items is collated. The collated set of items is sorted based on a predefined attribute associated with each item in the set. From the collated set, a list of one or more items is recommended to the client device. A number of items in the list is based on a receiving capacity of the client device.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIGS. 1-4 are schematics of network environments including an exemplary privacy-preserving recommendation (PPR) device, according to various embodiments of the present disclosure.

FIG. 5 is a schematic illustrating the exemplary PPR device of FIGS. 1-4, according to an embodiment of the present disclosure.

FIG. 6 illustrates an exemplary method of creating a data structure using an approximate rule fetch method performed by the PPR device of FIGS. 1-4, according to an embodiment of the present disclosure.

FIG. 7 illustrates an exemplary method of querying the data structure of FIG. 6 by the PPR device of FIGS. 1-4, according to an embodiment of the present disclosure.

FIG. 8 illustrates an exemplary method of creating an exemplary two-level data structure using an exact rule fetch method performed by the PPR device of FIGS. 1-4, according to an embodiment of the present disclosure.

FIG. 9 illustrates an exemplary method of querying the two-level data structure of FIG. 8 by the PPR device of FIGS. 1-4, according to an embodiment of the present disclosure.

FIG. 10 illustrates an exemplary method of implementing a top association criterion using the exact rule fetch method performed by the PPR device of FIGS. 1-4, according to an embodiment of the present disclosure.

FIG. 11 illustrates an exemplary method of implementing a privacy preserving protocol for privately collating recommended items by the PPR device of FIGS. 1-4, according to an embodiment of the present disclosure.

FIG. 12 illustrates an exemplary method of implementing a privacy preserving protocol for private data transfer by a client device in communication with the PPR device of FIGS. 1-4, according to an embodiment of the present disclosure.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Definitions

Definitions of one or more terms that will be used in this disclosure are described below without limitations. For a person ordinarily skilled in the art, it is understood that the definitions are provided just for the sake of clarity, and are intended to include more examples than just provided below.

An “association rule” is used in the present disclosure in the context of its broadest definition. The association rule refers to a function or a set of functions that establish a relation or correlation between similar or different items. Examples of these items may include, but not limited to, products and services. The association rule includes an antecedent that implies a consequent.

An “antecedent” is used in the present disclosure in the context of its broadest definition. The antecedent refers to an input to the association rule.

A “consequent” is used in the present disclosure in the context of its broadest definition. The consequent refers to an output of the association rule, where the output depends on the antecedent.

A “transaction” is used in the present disclosure in the context of its broadest definition. The transaction refers to an exchange of physical or virtual items such as products and services.

A “query” is used in the present disclosure in the context of its broadest definition. The query refers to a string including, but not limited to, text, numeric characters, alphanumeric characters, symbolic characters, images and graphics objects, or any combination thereof.

A “two-level data structure” is used in the present disclosure in the context of its broadest definition. The two-level data structure refers to a data structure that stores and symmetrically secures high dimensional data such as one or more association rules at two different levels for private access to the data.

“Collision” and “data collision” are used interchangeably in the present disclosure in the context of their broadest definition. The collision refers to an event when two distinct pieces of data have the same hash value or attempt to occupy the same location in a database.

A “collision probability” is used in the present disclosure in the context of its broadest definition. The collision probability refers to a probability of finding a non-empty location in a data structure for storing a new element.

A “universality of a hash function” is used in the present disclosure in the context of its broadest definition. The universality of a hash function refers to an ability of the hash function to exhibit a predetermined mathematical property despite of different or varying inputs to always yield an output that is logically consistent with the property.

A “file” is used in the present disclosure in the context of its broadest definition. The file refers to a computer readable, electronic file and related data in a variety of formats supporting storage, printing, or transfer of the file and related data over a communication channel. The file may be capable of being editable or non-editable, encrypted or decrypted, coded or decoded, compressed or decompressed, and convertible or non-convertible into different file formats and storage schemas, or any combination thereof. The file may be capable of being used by software applications to execute predetermined tasks or jobs.

A “document” is used in the present disclosure in the context of its broadest definition. The document refers to an electronic document including a single page or multiple pages. Each page may have text, graphic objects, images, embedded audios, embedded videos, embedded data files, or any combination thereof. The document may be a type of file.

A “user” is used in the present disclosure in the context of its broadest definition. The user refers to a person, a machine, an artificial intelligence unit, or any other entity, which communicates with one or more modules loaded or integrated with an electronic device capable of or configured to perform a specific function. The entity may include a group of persons or organizations such as professional services organizations, product manufacturing organizations, finance management organizations, real estate organizations, marketing firms, marketplaces, and so on that can operate online over e-commerce portals.

A “client device” is used in the present disclosure in the context of its broadest definition. The client device refers to a standalone or a networked computing device capable of handling electronic images, and may host various applications to request services from other devices connected to a network. Various examples of the user device include a desktop PC, a personal digital assistant, a mobile computing device (e.g., mobile phones, laptops, tablets, etc.), a server, an Internet-of-things (IOT) device, an artificial intelligence system, etc.

The numerous references in the disclosure to a privacy-preserving recommendation (PPR) device are intended to cover any and/or all devices capable of performing respective operations for oblivious transfer of data in a cloud environment relevant to the applicable context, regardless of whether or not the same are specifically provided.

### Overview

Various embodiments of the present disclosure describe devices and methods for privacy preserving product recommendation using association rules by a server in the cloud given a set of products (transaction) as an input. In the setting where association rules mined from transaction data are typically very large, a privacy preserving recommendation (PPR) device recommends products in a computationally efficient manner, using the theory of locality sensitive hashing. Various rule fetch methods including approximate rule fetch and exact rule fetch methods are embedded in a privacy preserving protocol such that a server that stores the association rules learns nothing more about the transaction presented and the one receiving the recommendations learns nothing more about the association rules than what they can derive from the transaction and the recommended items. The PPR device provides an advantageous way to allow association rules to be fired quickly against a database while preserving privacy.

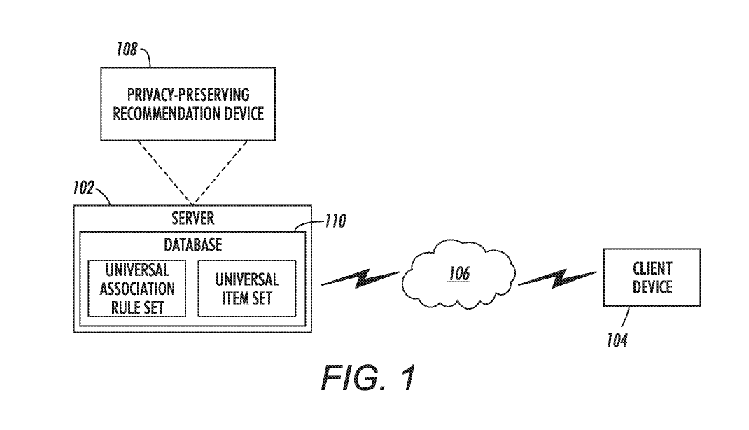

FIGS. 1-4 are schematics of network environments including an exemplary privacy-preserving recommendation (PPR) device, according to various embodiments of the present disclosure. Embodiments are discussed in the context of online users shopping on e-commerce portals. However, in general, the embodiments may be implemented in any privacy-preserving scenarios that require interacting entities to reveal their minimum possible information to each other. Examples of such scenarios may include, but are not limited to, digital voucher generation, cyber bids, online surveys, and electronic payments.

The illustrated embodiments (FIGS. 1-4) include a server 102 in communication with a client device 104 over a network 106. The network 106 may include any software, hardware, or computer applications that can provide a medium to exchange signals or data in any of the formats known in the art, related art, or developed later. The network 106 may include, but is not limited to, social media platforms implemented as a website, a unified communication application, or a standalone application. Examples of the social media platforms may include, but are not limited to, Twitter™, Facebook™, Skype™ Microsoft Lync™, Cisco Webex™, and Google Hangouts™. Further, the network 106 may include, for example, one or more of the Internet, Wide Area Networks (WANs), Local Area Networks (LANs), analog or digital wired and wireless telephone Networks (e.g., a PSTN, Integrated Services Digital Network (ISDN), a cellular network, and Digital Subscriber Line (xDSL), Wi-Fi, radio, television, cable, satellite, and/or any other delivery or tunneling mechanism for carrying data. The network 106 may include multiple networks or sub-networks, each of which may include, for example, a wired or wireless data pathway. The network 106 may include a circuit-switched voice network, a packet-switched data network, or any other network able to carry electronic communications. For example, the network 106 may include networks based on the Internet protocol (IP) or asynchronous transfer mode (ATM), and may support voice using, for example, VoIP, Voice-over-ATM, or other comparable protocols used for voice, video, and data communications.

In a first exemplary embodiment (FIG. 1), the PPR device 108 may be installed on, integrated, or operatively associated with the server 102. The server 102 may be implemented as any of a variety of computing devices including, for example, a general purpose computing device, multiple networked servers (arranged in clusters or as a server farm), a mainframe, or so forth. The server 102 includes a database 110, which may be sub-divided into further databases for storing electronic files. The database 110 may have one of many database schemas known in the art, related art, or developed later for storing the data, predefined or dynamically defined models, and parameter values. For example, the database 110 may have a relational database schema involving a primary key attribute and one or more secondary attributes. In one embodiment, the database 110 may be a private database whose contents are inaccessible by an interacting entity, for example, a networked device, an artificial intelligence, etc., unless queried based on a predefined task such as a privacy preserving item recommendation.

In one embodiment, the database 110 stores a universal association rule set and a universal item set. The universal association rule set refers to a collection of predefined association rules that provide a correlation between same or different type of items based on a history of user purchase data, which may include the universal item set, or a part thereof. Each association rule may be defined as shown in equation 1.

p→q (1)

where

p=antecedent and q=consequent

Equation (1) indicates that if an event p has occurred, then an event q is likely to occur. In the context of the disclosure where a user is shopping for items on one or more e-commerce portals, each of the p and q refers to a collection of items, where p may be a set of one or more transacted items, i.e., items that are purchased or collated in a virtual shopping basket, and q may be a set of one or more recommended items based on the items purchased or collated by the user. Further, the universal item set refers to a list of items available for view or purchase to the user on one or more client devices, such as the client device 104, in communication with the server 102. In some embodiments, the universal association rule set and the universal item set may be stored together or separately on the server 102, the PPR device 108, the client device 104, or any other networked device or repository.

The PPR device 108 is preconfigured or dynamically configured to, at least one of, (1) communicate synchronously or asynchronously with one or more software applications, databases, storage devices, or appliances operating via same or different communication protocols, formats, database schemas, platforms or any combination thereof, to appropriately select and apply association rules corresponding to a given transaction; (2) formulate novel criteria or metrics that define the relevancy of association rules for the transaction; (3) differentiate the novel criteria under different metrics defined by various parameters, for example, a threshold weight of an association rule, an antecedent threshold length, a count of maximum number of relevant association rules to be selected under different metrics, etc.; (4) implement the novel criteria using (i) a novel fast randomized approximation (FRA) rule fetch method or (ii) a fast exact parallel (FEP) rule fetch method, which is based on a novel two-level data structure, or a combination thereof, for appropriate matching of antecedents and quick fetching of corresponding consequents; (5) implement the FRA rule fetch method and the FEP rule fetch method either under a normal mode or a privacy preserving (PP) mode based on a user input; (6) build the novel two-level data structure to store and symmetrically secure the association rules at two different levels for private data access; (7) compute, communicate, or display an ordered list of items being recommended based on the fetched consequents while preserving the privacy of the transaction; (8) formulate one or more tasks for being performed on or trained from the association rules and the universal item set; (9) provide, execute, communicate, and assist in formulating one or more mathematical models for tasks related to efficient selection and application of association rules for privacy preserving item recommendations; (10) efficiently mine databases for the association rules (including related antecedents and consequents) and the universal item set; (11) transfer or map the models, tasks, attributes, attribute values, and list of recommended items, or any combination thereof, to one or more networked computing devices and/or data repositories.

The PPR device 108 may represent any of a wide variety of devices capable of providing privacy-preserving item recommendation as a service to the network devices. Alternatively, the PPR device 108 may be implemented as a software application, a device driver, or a technical functionality. The PPR device 108 may enhance or increase the functionality and/or capacity of the network, such as the network 106, to which it is connected. In some embodiments, the PPR device 108 may be also configured, for example, to perform e-mail tasks, security tasks, network management tasks including Internet protocol (IP) address management, and other tasks. In some other embodiments, the PPR device 108 may be further configured to expose its computing environment or operating code to a user, and may include related art I/O devices, such as a keyboard or display. The PPR device 108 of some embodiments may, however, include software, firmware, or other resources that support the remote administration and/or maintenance of the PPR device 108.

In further embodiments, the PPR device 108 either in communication with any of the networked devices such as the server 102, or dedicatedly, may have video, voice, or data communication capabilities (e.g., unified communication capabilities) by being coupled to or including, various imaging devices (e.g., cameras, printers, scanners, medical imaging systems, etc.), various audio devices (e.g., microphones, music players, recorders, audio input devices, speakers, audio output devices, telephones, speaker telephones, etc.), various video devices (e.g., monitors, projectors, displays or display screens, televisions, video output devices, video input devices, camcorders, etc.), or any other type of hardware, in any combination thereof. In some embodiments, the PPR device 108 may comprise or implement one or more real time protocols (e.g., session initiation protocol (SIP), H.261, H.263, H.264, H.323, etc.) and non-real-time protocols known in the art, related art, or developed later to facilitate data transfer between the server 102, the client device 104, and the PPR device 108, or any other network device.

In some embodiments, the PPR device 108 may be configured to convert communications, which may include instructions, queries, data, files, etc., from the client device 104 into appropriate formats to make these communications compatible with the server 102, and vice versa. Consequently, the PPR device 108 may allow implementation of the server 102 using different technologies or by different organizations, for example, a third-party vendor, managing the server 102 or associated services using a proprietary technology.

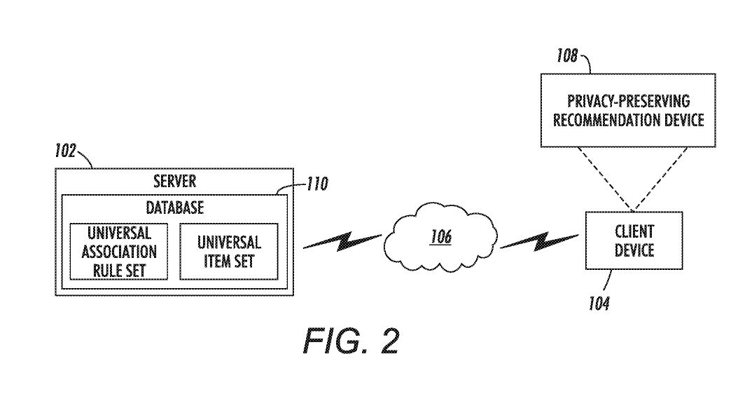

In a second embodiment (FIG. 2), the PPR device 108 may be integrated, installed on, or operated with the client device 104, which may be any computing device known in the art, related art, or developed later and operable by a user. The client device 104 may operate as a standalone device or as a peripheral device to network devices such as the server 102.

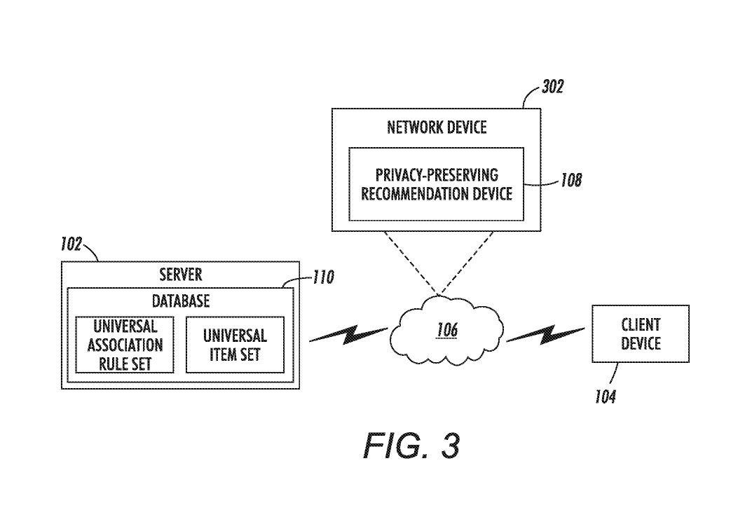

In a third embodiment (FIG. 3), the PPR device 108 may be integrated, installed on or operated with a network appliance 302 configured to establish the network 106 among the server 102 and the client device 104. One of: the PPR device 108 and the network appliance 302 may be capable of operating as or providing an interface to assist the exchange of software instructions and data between the server 102 and the client device 104. In some embodiments, the network appliance 302 may be preconfigured or dynamically configured to include the PPR device 108 integrated with other devices. For example, the PPR device 108 may be integrated with the server 102 (as shown in FIG. 1) or any other computing device connected to the network 106. The server 102 may include a module (not shown), which enables the server 102 being introduced to the network appliance 302, thereby enabling the network appliance 302 to invoke the PPR device 108 as a service. Examples of the network appliance 302 include, but are not limited to, a DSL modem, a wireless access point, a router, a base station, and a gateway having a predetermined computing power and memory capacity sufficient for implementing the PPR device 108.

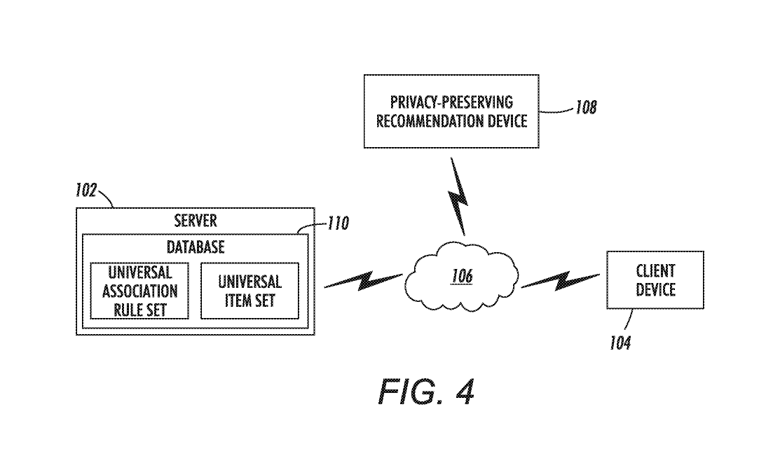

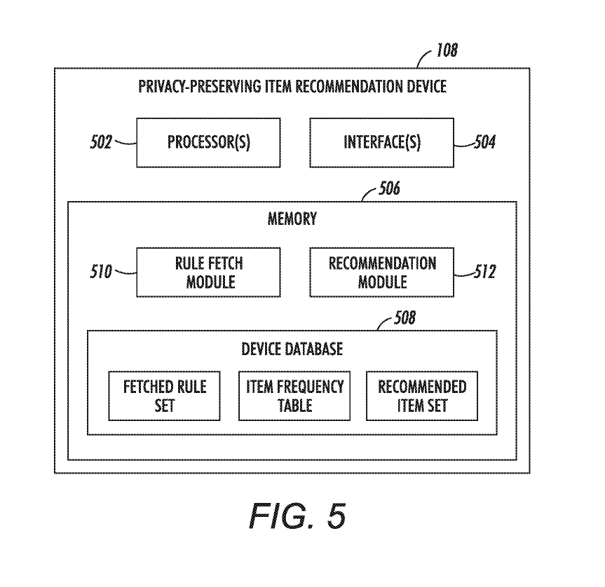

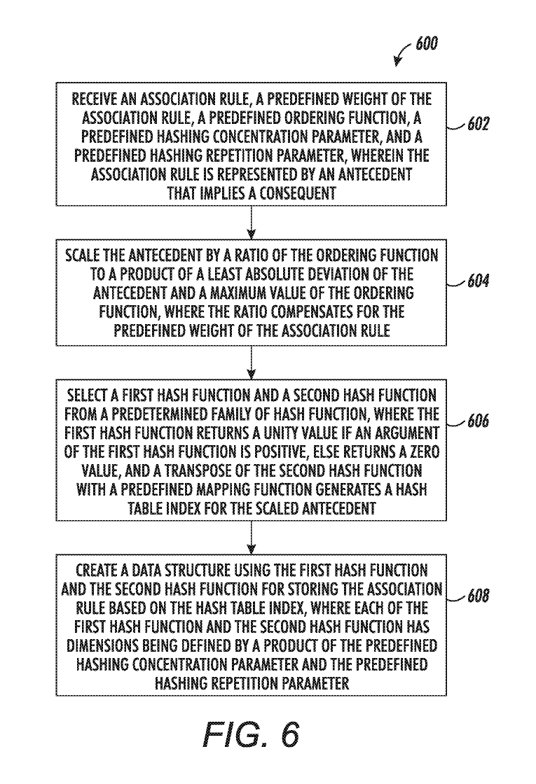

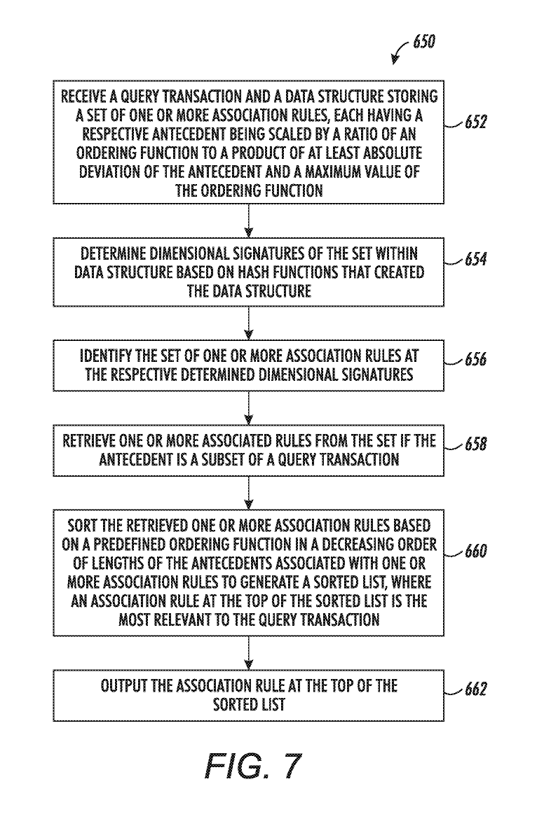

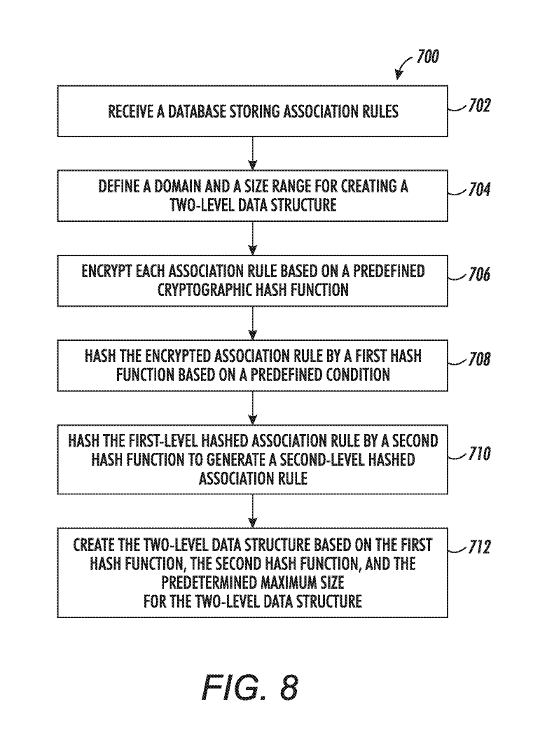

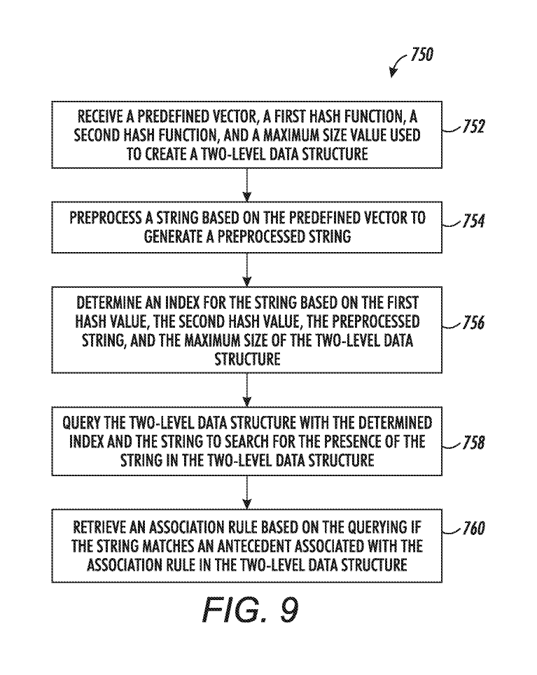

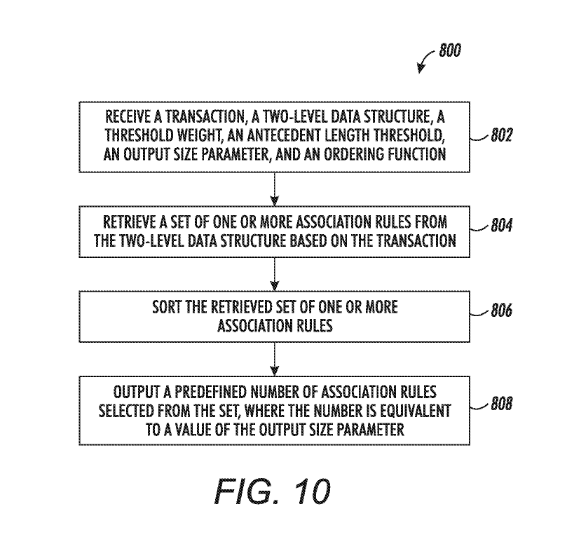

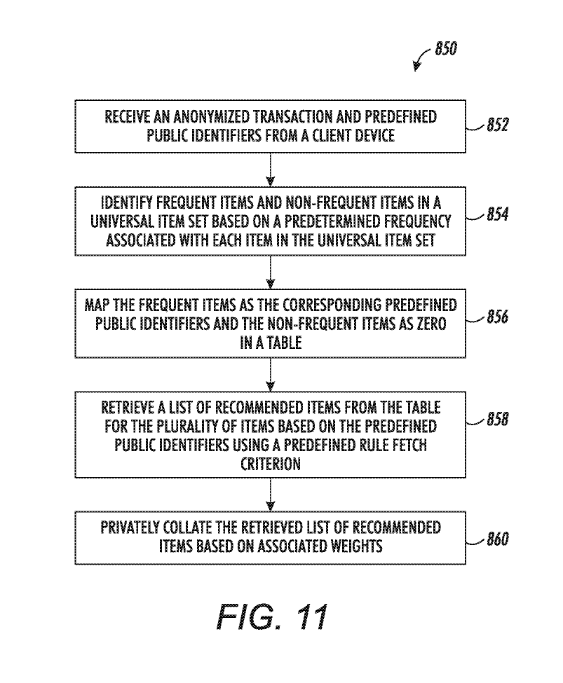

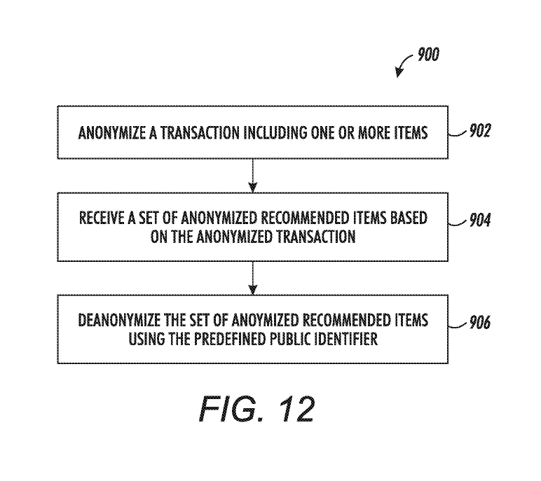

In a fourth embodiment (FIG. 4), the PPR device 108 may operate as a standalone device. The PPR device 108 may include its own processor(s) 502 (shown in FIG. 5) and a transmitter and receiver (TxRx) unit (not shown). In such embodiment, the server 102, the client device 104, and the PPR device 108 may be implemented as dedicated devices communicating with each other over the network 106. Accordingly, the PPR device 108 may communicate directly with the networked devices, for example, the server 102, the client device 104, etc., using the TxRx unit.

FIG. 5 is a schematic illustrating the exemplary PPR device 108 of FIGS. 1-4, according to an embodiment of the present disclosure. The PPR device 108 may be implemented by way of a single device (e.g., a computing device, a processor or an electronic storage device) or a combination of multiple devices that are operatively connected or networked together. The PPR device 108 may be implemented in hardware or a suitable combination of hardware and software. In some embodiments, the PPR device 108 may be a hardware device including processor(s) 502 executing machine readable program instructions to (1) communicate synchronously or asynchronously with one or more software applications, databases, storage devices, or appliances operating via same or different communication protocols, formats, database schemas, platforms or any combination thereof, to appropriately select and apply association rules corresponding to a given transaction; (2) formulate novel criteria or metrics that define the relevancy of association rules for the transaction; (3) differentiate the novel criteria under different metrics defined by various parameters, e.g., a threshold weight of an association rule, an antecedent threshold length, a count of maximum number of relevant association rules to be selected under different metrics, etc.; (4) implement the novel criteria using (i) a novel fast randomized approximation (FRA) rule fetch method or (ii) a fast exact parallel (FEP) rule fetch method, which is based on a novel two-level data structure, or a combination thereof, for appropriate matching of antecedents and quick fetching of corresponding consequents; (5) implement the FRA rule fetch method and the FEP rule fetch method either under a normal mode or a privacy preserving (PP) mode based on a user input; (6) build the novel two-level data structure to store and symmetrically secure the association rules at two different levels for private data access; (7) compute, communicate, or display an ordered list of items being recommended based on the fetched consequents while preserving the privacy of the transaction; (8) formulate one or more tasks for being performed on or trained from the association rules and the universal item set; (9) provide, execute, communicate, and assist in formulating one or more mathematical models for tasks related to efficient selection and application of association rules for privacy preserving item recommendations; (10) efficiently mine databases for the association rules (including related antecedents and consequents) and the universal item set; (11) transfer or map the models, tasks, attributes, attribute values, and list of recommended items, or any combination thereof, to one or more networked computing devices and/or data repositories; or any combination thereof.

The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor(s) 502 may include, for example, microprocessors, microcomputers, microcontrollers, digital signal processors, central processing units, state machines, logic circuits, and/or any devices that manipulate signals based on operational instructions. Among other capabilities, the processor(s) 502 may be configured to fetch and execute computer readable instructions in a dedicated or shared memory, such as a memory 506, associated with the PPR device 108 for performing tasks such as signal coding, data processing input/output processing, power control, and/or other functions.

In some embodiments, the PPR device 108 may include, in whole or in part, a software application working alone or in conjunction with one or more hardware resources. Such software applications may be executed by the processor(s) 502 on different hardware platforms or emulated in a virtual environment. Aspects of the PPR device 108 may leverage known, related art, or later developed off-the-shelf software. Other embodiments may comprise the PPR device 108 being integrated or in communication with a mobile switching center, network gateway system, Internet access node, application server, IMS core, service node, or any other type of communication systems, including any combination thereof. In some embodiments, the PPR device 108 may be integrated with or implemented as a wearable device including, but not limited to, a fashion accessory (e.g., a wristband, a ring, etc.), a utility device (a hand-held baton, a pen, an umbrella, a watch, etc.), a body clothing, and a safety gear, or any combination thereof.

The PPR device 108 may also include a variety of known, related art, or later developed interface(s), such as interface(s) 504, including software interfaces (e.g., an application programming interface, a graphical user interface, etc.); hardware interfaces (e.g., cable connectors, a keyboard, a card reader, a barcode reader, a radio frequency identity (RFID) reader, a biometric scanner, an RFID scanner, an interactive display screen, a transmitter circuit, a receiver circuit, etc.); or both.

The PPR device 108 further includes the memory 506 for storing, at least one of, (1) files and related data including metadata, for example, data size, data format, creation date, associated tags or labels, images, documents, messages or conversations, a list of recommended items, rule fetch criteria, various parameters and their values, etc.; (2) a log of profiles of network devices and associated communications including instructions, queries, conversations, data, and related metadata; and (3) predefined or dynamically defined or calculated mathematical models, equations, or methods for privacy-preserving recommendation of items.

The memory 506 may comprise of any computer-readable medium known in the art, related art, or developed later including, for example, a processor or multiple processors operatively connected together, volatile memory (e.g., RAM), non-volatile memory (e.g., flash, etc.), disk drive, etc., or any combination thereof. The memory 506 may include one or more databases such as a device database 508, which may be sub-divided into further databases for storing electronic files. The memory 506 may have one of many database schemas known in the art, related art, or developed later for storing the data, predefined or dynamically defined models, recommendation criteria, and parameter values. For example, the device database 508 may have a relational database schema involving a primary key attribute and one or more secondary attributes. In one embodiment, the device database 508 is preconfigured or dynamically configured with a novel two-level data structure for storing and symmetrically securing high-dimensional data such as strings (e.g., association rules and inherent names of items being part of antecedents and/or consequents of the association rules), discussed below in greater detail.

In some embodiments, the PPR device 108 may perform one or more operations including, but not limited to, reading, writing, deleting, searching, querying, indexing, segmenting, labeling, updating, and modifying the data, or a combination thereof, and may communicate the resultant data to various networked devices. In one embodiment, the memory 506 includes various modules such as a rule fetch module 510 and a recommendation module 512.

Given a query transaction T from the client device 104, the PPR device 108 may divide a task of item recommendations into two logical steps, namely, a fetch step and a collate step. The fetch step may be performed by the rule fetch module 510 and the collate step may be performed by the recommendation module 512. The rule fetch module 510 may fetch a set of association rules applicable to a transaction performed by a user, or user transaction, using novel methods based on one or more predefined rule fetch criteria. Such criteria and methods are integral to accurate item recommendations because: (a) the transaction may be similar to antecedents of many association rules according to different criteria or metrics based on various parameters, discussed below in detail, (b) the association rules may have additional attributes that reflect their significance for the given transaction, and (c) after association rules have been selected, there may be potentially multiple ways to prepare a final ordered list of recommended items based on the selected association rules.

### Rule Fetch Module

The rule fetch module 510 is preconfigured or dynamically configured to (1) receive a transaction indicated by a query, referred to as a query transaction T, from the client device 104 or any other network device; (2) receive a user input to select one or more predefined rule fetch criteria; (3) fetch one or more association rules applicable to the query transaction based on the selected rule fetch criterion; (4) implement any of the rule fetch criteria using either a novel fast randomized approximation rule fetch (or approximation rule fetch) method, or (ii) a fast exact parallel rule fetch (or exact rule fetch) method; (5) receive a user input to implement the approximation rule fetch method and the exact rule fetch method either under a normal mode or a privacy preserving (PP) mode; and (6) build a novel two-level data structure to store and symmetrically secure the association rules at two different levels for private data access.

The query transaction T may include or indicate a set of one or more items (e.g., butter, bread, pen, towel, table, shoes, etc.) from an ongoing purchase transaction, e.g., items collated in a virtual shopping basket, or from an earlier purchase transaction made by the user on the client device 104. These set of items may act as antecedents that may be matched to a consequent, for example, a set of one or more items for recommendation, based on one or more association rules which can be defined as shown in equation (2).

{pᵢ→qᵢ}ᵢ₌₁^{D} (2)

where

pᵢ=antecedent

qᵢ=consequent

D=total number of association rules in a database; D>0

i=sequence number of an association rule

The query transaction [symbol] may be defined as shown in equation 3, which represents that the query transaction [symbol] is a subset or part of the universal item set, which may be stored on the server 102 and accessible for being viewed on the client device 104 by the user.

[symbol]

⊂ [symbol] (3)

where

[symbol] =Transaction or query transaction

[symbol] =Universal Item Set

In Equation (3), the entity [symbol] may represent two possibilities for each item in the query transaction [symbol] . The first possibility refers that an item has already been purchased by the user and the second possibility refers to the same item being part of an ongoing transaction, for example, the item being saved in a virtual shopping cart.

Once the query transaction [symbol] is received, the rule fetch module 510 may request the user to select one of the predefined rule fetch criteria. Such user input may be received from the client device 104, a network device, or directly at the PPR device 108 via an input device such as a keyboard (not shown) to select a predefined rule fetch criterion. In some embodiments, a rule fetch criterion may be selected automatically based on a single or a combination of predefined conditions. For example, the rule fetch module 510 may automatically select a predefined rule fetch criterion when a query transaction [symbol] is received from a pre-identified client device such as the client device 104 or through a known network such as the network 106.

In one embodiment, the predefined rule fetch criteria includes a top association criterion, a maximum association criterion, an all association criterion, and an any association criterion for selecting the applicable association rules for the given query transaction [symbol] . Among these predefined rule fetch criteria, each criterion may be differentiated from the other based on one or more parameters such as a threshold weight w, an antecedent length threshold t, and a top rule count, k. The threshold weight w refers to a limit on a weight or importance score of an association rule. The importance score of an association rule is predetermined or dynamically determined by the rule fetch module 510 using any of the variety of techniques known in the art, related art, or developed later. The antecedent length threshold t refers to a threshold or limit on a word length of an antecedent. For example, a string “butter” received as a query transaction T or being an antecedent may have a word length of six. Further, the top rule count k refers to a maximum number of top association rules in a set of association rules being determined to be applicable to the query transaction [symbol] , where the top most association rule in the set may be most relevant to the query transaction [symbol] . Each of these parameters may be an element of [symbol] ₊, i.e., w, t, k∈ [symbol] ₊, where [symbol] ₊ may represent a complex function. The predefined rule fetch criteria are discussed below in greater detail.

### Top Association Criterion

The top association criterion, as defined in equation (4), may be based on the three parameters, i.e., w, t, and k, and an ordering function ƒ to filter and output the association rules.

$$T O P - Assoc ( k , w , t , f ) = {max}_{x ∈ {\{ 0 , 1 \}}^{D}} {\sum }_{i} {x}_{i} \cdot f ( i ) s . t . {\sum }_{i} {x}_{i} \leq k \\ and {x}_{i} \leq min \{ 1 [ \vert {p}_{i} \vert \leq t ] , 1 [ {w}_{i} \geq w ] , 1 [ {p}_{i} ⊆ 𝒥 ] \} \qquad ( 4 )$$

where

xᵢ=an association rule

i=sequence number of the association rule

w=threshold weight

wᵢ=importance score or weight of the association rule xᵢ

t=antecedent length threshold

|pᵢ|=word length (or just, length) of an antecedent of the association rule xᵢ

ƒ=ordering function, where ƒ: {1, . . . , D}→

[symbol]

k=top rule count

According to the parameter w in equation (4), the top association criterion may filter out, or ignore, association rules with weights less than the predefined threshold weight, represented by wᵢ≥w. Similarly, the top association criterion may retain association rules with antecedents of lengths less than the predefined antecedent length threshold, represented by |pᵢ|≤t in equation (4). The top association criterion may also control the maximum number of applicable association rules that are eventually outputted for use by the rule fetch module 510 based on the parameter k, represented by Σᵢxᵢ≤k in equation (4). For example, as shown in equation (4), a set of top association rules may output association rules less than or equal to a value of k. The values of these parameters w, t, and k may be predefined or dynamically defined by a user, the rule fetch module 510, or a network device.

Further, the ordering function ƒ determines which of the association rules are the top k association rules. Thus, both the ordering function ƒ and the applicability condition of the antecedent being a subset of the transaction [symbol] , i.e., pᵢ⊆ [symbol] , together filter and determine the k elements or association rules that are to be eventually outputted by the rule fetch module 510. In one embodiment, the ordering function ƒ may be defined to arrange the association rules in a decreasing order of: (a) their weights wᵢ, i.e., ƒ(i)=wᵢ; (b) antecedent lengths |pᵢ|, i.e., ƒ(i)=|pᵢ|; or (c) a linear/non-linear combination of both (a) and (b). In a first instance, the ordering function ƒ may be defined as shown in equation (5) to order the association rules according to both their antecedent lengths as well as their weights, where antecedent lengths may be set to have a preference over the weight in case of multiple association rules having the same values of weights or antecedent lengths.

ƒᵢ=g₁(wᵢ)+g₁(wₘₐₓ)·g₂(|pᵢ|) (5)

where

ƒ: {1, . . . , D}→

[symbol]

In equation (5), g₁ and g₂ may be strictly monotonic integer-valued functions of their respective arguments, and constant wₘₐₓ=maxᵢ=1, . . . , D^{w}^{ᵢ}. The function ƒᵢ of equation (5) may be defined to satisfy predetermined properties. One example of such properties may include a function ƒ(1) being less than or equal to another function ƒ(2), i.e., ƒ(1)≤ƒ(2), for any pair of association rules with weight attributes w₁ and w₂, where w₁ is less than w₂ without the loss of generality, and a length of an antecedent p₁ is equal to a length of an antecedent p₂, i.e., |p₁|=|p₂|. Another example of such property may include ƒ(1)≤ƒ(2) for any pair of association rules with weight attributes w₁ and w₂, and antecedents p₁ and p₂ such that |p₁|<|p₂|.

In a second instance, the function ƒ may be defined as shown in equation (6) to order the association rules according to both their antecedent lengths and weights, where weights may be set to have preference over the antecedent lengths in case of multiple association rules having the same values of weights or antecedent lengths.

ƒᵢ=g₂(|pᵢ|)+ [symbol] ·g₁(wᵢ) (6)

In equation (6), g₁ and g₂ may be same as defined above and the properties for function ƒ in equation (6) may be derived similar to those as discussed above for equation (5).

### All-Association Criterion

The all-association criterion is another special case of the top association criterion when k, i.e., the top rule count, is equivalent to D, i.e., total number of predefined association rules in the universal association rule set on the server 102. Accordingly, the all-association criterion, defined in equation (7), may cause the rule fetch module 510 to filter the universal association rule set and output all possible association rules that are applicable to the query transaction [symbol] .

$$ALL - Assoc ( w , t ) = {max}_{x ∈ {\{ 0 , 1 \}}^{D}} {\sum }_{i} {x}_{i} s . t . {x}_{i} \leq min \{ 1 [ \vert {p}_{i} \vert \leq t ] , 1 [ {w}_{i} \geq w ] , 1 [ {p}_{i} ∈ 𝒥 ] \} \qquad ( 7 )$$

According to equation (7), the all-association criterion may filter the universal association rule set to output association rules that have antecedents having lengths less than or equal to the predefined antecedent length threshold and have weights greater than or equal to the predefined threshold weight.

### Any-Association Criterion

The any-association criterion, as defined in equation (8), may filter the universal association rule set to output at most k applicable association rules with weights greater than or equal to a predefined weight threshold, and antecedent lengths being less than or equal to the predefined antecedent length threshold.

$$ANY - Assoc ( k , w , t ) = {max}_{x ∈ {\{ 0 , 1 \}}^{D}} {\sum }_{i} {x}_{i} s . t . {\sum }_{i} {x}_{i} \leq k and {x}_{i} \leq min \{ 1 [ \vert {p}_{i} \vert \leq t ] , 1 [ {w}_{i} \geq w ] , 1 [ {p}_{i} ∈ 𝒥 ] \} \qquad ( 8 )$$

According to equation (8), the any-association criterion is similar to the all-association criterion with an exception of a limitation on the maximum number of applicable association rules that can be outputted by the rule fetch module 510.

### Maximum Association Criterion

The maximum association criterion is also a special case of the top association criterion when k (top rule count)=1, w (threshold weight)=0, and t (antecedent length threshold)=| [symbol] |, i.e., the antecedent length threshold is set to be equivalent to the total length, or word length, of the universal item set stored on the server 102. Accordingly, the maximum association criterion may output only a single applicable association rule based on equation (9).

$$MAX - Assoc ( f ) = {max}_{i ∈ D} f ( i ) s . t . {p}_{i} ⊆ 𝒥 ∀ 1 \leq i \leq D \qquad ( 9 )$$

Equation (9) represents the MAX−Assoc(ƒ) being combined with a requirement that refers to the antecedent, pᵢ=p_{top rule}, of a top rule, i.e., the most relevant association rule, to be contained as a subset of the query transaction [symbol] , i.e., p_{top rule}⊆ [symbol] .

In one embodiment, the predefined rule fetch criteria may belong to a new class of search criteria called as a Generalized Subset Containment Search (GSCS) criteria, where a special case of this class defines an association rule to be relevant for a query transaction [symbol] if an antecedent of that association rule has the largest subset contained in the query transaction [symbol] . This special case may be called as the Largest Subset Containment Search (LSCS) criteria. Based on the LSCS criteria class, each of the rule fetch criteria are based on a predetermined condition defined by Definition 1:
Definition 1: “Each association rule, which is tracked by its sequence number i, may be applicable to a query transaction [symbol] if and only if an antecedent pᵢ is a subset of the query transaction [symbol] , i.e., pᵢ⊆ [symbol] .”

LSCS criteria and its generalization, i.e., GSCS criteria, may be understood based on any of the novel rule fetch criteria discussed above. For the sake of simplicity and brevity, the maximum association criterion is used below to explain how these rule fetch criteria solve an LSCS problem, and therefore a GSCS problem, for accurate selection of association rules that apply to the query transaction [symbol] . However, a person having ordinary skill in the art would understand that the LSCS problem, and so the GSCS problem, are resolvable using any of the remaining rule fetch criteria, namely, the top-association, all-association, and any-association criteria.

The LSCS problem can be defined as shown in equation (10) and the GSCS problem can be defined as shown in equation (11).

$$\begin{matrix}L S C S problem \text{:} {max}_{i ∈ D} {\sum }_{j = 1}^{\vert {𝒯}_{\sim} \vert} {𝒥}^{j} \cdot {p}_{i}^{j} s . t . {p}_{i}^{j} \leq {𝒥}^{j} & ( 10 ) \\ where & \\ {p}_{i}^{j} = {j}^{th} coordinate of vector {p}_{i} ∈ {\{ 0 , 1 \}}^{\vert {𝒯}_{\sim} \vert} ; and & \\ 1 \leq j \leq \vert {𝒯}_{\sim} \vert & \\ G S C S problem \text{:} {max}_{i ∈ D} f ( i ) \cdot {\sum }_{j = 1}^{\vert {𝒯}_{\sim} \vert} {𝒥}^{j} \cdot {p}_{i}^{j} s . t . {p}_{i}^{j} \leq {𝒥}^{j} & ( 11 ) \\ where & \\ 1 \leq i \leq D and 1 \leq j \leq \vert {𝒯}_{\sim} \vert & \\ {p}_{i}^{j} = {j}^{th} coordinate of vector {p}_{i} ∈ {\{ 0 , 1 \}}^{\vert {𝒯}_{\sim} \vert} & \\ f ( i ) = ordering function & \end{matrix}$$

Equations (10) and (11) establish that LSCS problem is a special case of the GSCS problem when the ordering function, ƒ(i), is equal to 1 for all 1≤i≤D. This implies that the ordering function, which determines a top or most relevant association rule, is only dependent on the antecedent length pᵢ^{j}, through an inner product term [symbol] ^{j}·pᵢ^{j}, and not on any other attribute, such as weights, of the association rules. The GSCS problem can account for various ordering functions, i.e., (i), as discussed above.

The LSCS problem attempts to find a set, i.e., a characteristic vector whose inner product with a [symbol] vector is the highest among all vectors whose corresponding sets are subsets of [symbol] . The characteristic vector represented by pᵢ^{j} (set characteristic vector notation) may correspond to an antecedent of an association rule and the [symbol] vector may represent a query transaction in equation (10). The LSCS problem may be solved using the maximum association criterion based on the conditions defined in equations (12) and (13). In equation (12), ∥pᵢ∥₁ corresponds to the Iᵢ-norm of pᵢ vector and represents least absolute deviations or errors while matching items in the query transaction, i.e., [symbol] ^{j}, with the antecedents, i.e., pᵢ^{j}, of association rules.

If pᵢ⊆ [symbol] , then ∥pᵢ∥= [symbol] pᵢ^{j}· [symbol] ^{j} (12)

When ƒ(i)=1∀1≤i≤D, (13)
Max−Assoc(ƒ) criterion is equivalent to the LSCS problem

The LSCS problem of equation (10) is similar to a traditional problem of Maximum Inner Product Search (MIPS), defined in equation (14), corresponding to finding a data vector r* that maximizes the inner product with a query vector s∈ [symbol] ^{d}, where [symbol] refers to real values and d refers to a dimension of the vector space.

$$r ⋆ ∈ arg {max}_{1 \leq i \leq D} {\sum }_{j = 1}^{d} {r}_{i}^{j} {s}^{j} \qquad ( 14 )$$

where

rᵢ^{j}=j^{th} coordinate of database vectors rᵢ∈ [symbol] ^{d}, 1≤i≤D

The equation (14) can be normalized based on the dimension d being equal to | [symbol] |, the database vectors rᵢ being equal to normalized antecedent vectors, i.e.,

$${r}_{i} = \frac{1}{{‖ {p}_{i} ‖}_{1}} {p}_{i}$$

with pᵢ∈{0, [symbol] , 1≤i≤D, and s being equal to [symbol] ∈{0, [symbol] . Such normalization ensures that smaller length antecedents are preferred over larger length antecedents in the MIPS instance to mimic the subset containment or applicable property, i.e., an association rule i is applicable to a transaction [symbol] if and only if pᵢ⊆ [symbol] . Intuitively, due to this normalization the solutions of MIPS and LSCS instances are close to each other, but while an optimal solution of LSCS problem is an optimal solution for the MIPS problem, vice versa is not true. Therefore, LSCS conditions defined in the equations (12) and (13) are useful to design efficient rule fetch methods that may efficiently fetch association rules from the database 110 on the server 102, where these association rules are determined to be applicable to the query transaction [symbol] based on the selected rule fetch criterion.

In one embodiment, the rule fetch module 510 defines the approximate rule fetch method (or approximate method) based on the equations (12) and (13), and the exact rule fetch method (or exact method) to fetch the applicable association rules from the database 110 based on any of the novel rule fetch criteria discussed above. Each of these two novel methods involves steps of (1) pre-processing the database 110 of association rules to create a data structure for efficiently storing the association rules so that they can be fetched quickly, and (2) querying the data structure with a query transaction to obtain a list of applicable association rules based on any of the selected rule fetch criterion discussed above. Each of the approximate and the exact methods can be implemented either under a normal mode or a private mode based on a user selection.

### Approximate Rule Fetch Method

For the sake of simplicity and brevity, the approximate rule fetch method is described to fetch the top most applicable association rule, corresponding to the MAX−Assoc(ƒ) criterion, discussed above, under an ordering preference that prefers applicable rules with large antecedents. In particular, the objective of the approximate rule fetch method is to output an association rule with the largest antecedent set contained within the query transaction or set [symbol] if the antecedent set is unique, i.e., lengths of antecedents contained within the query transaction [symbol] are different. Else, the objective is to output the association rule with the highest weight among the collection of association rules with the largest contained antecedents when the all the antecedents contained within the query transaction have the same largest length. Such ordering preference leads to an instance of the GSCS problem, hereinafter referred to as a GSCS instance.

Under the normal mode selected by a user, the approximate rule fetch method involves an Approx-GSCS-Prep step and an Approx-GSCS-Query step, which together solve the GSCS instance. The Approx-GSCS-Prep step is discussed with respect to an exemplary method 600, which may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 600 is described is not intended to be construed as a limitation, and any number of the described method blocks may be combined or otherwise performed in any order to implement the method 600 or an alternate method. Additionally, individual blocks may be deleted from the method 600 without departing from the spirit and scope of the present disclosure described herein. Furthermore, the method 600 may be implemented in any suitable hardware, software, firmware, or combination thereof, that exists in the related art or that is later developed.

In one embodiment, the method 600 relies on the inner product similarity measure based on properties of hashing functions and guarantees a sound retrieval quality. The similarity measure impacts the appropriateness of the hashing functions and the approximation quality. The properties of the hashing functions may be defined as in Definition 2:
Definition 2: “For a domain D of points, a family [symbol] ={h: [symbol] → [symbol] } is called locality sensitive, if for any query q, the function [symbol] _{H}[h(q)=h(v):sim(q, v)=t] is strictly increasing in t, where sim(a, b) measures the similarity between two points a and b.”

At 602, an association rule, a predefined weight of the association rule, a predefined ordering function, a predefined hashing concentration parameter, and a predefined hashing repetition parameter are received. The association rule may be represented by an antecedent that implies a consequent. The weight of the association rule may be predefined based on any of a variety of associative classification schemes known in the art, related art, or developed later including Classification based Association (CBA), Classification based on Multiple Association Rules (CMAR), and Classification based on Predictive Association Rules (CPAR). The ordering function may be any function, as discussed above that may select an association rule among multiple association rules based on its weight if antecedents of that association rule and another association rule are of equal lengths. The hashing concentration parameter and a hashing repetition parameter are dimensional parameters that amplify a gap between collision probabilities of nearby and similar points, representing antecedents, and far away or dissimilar points when antecedents, and thus the corresponding association rules, are stored in a data structure. The hashing concentration and the repetition parameters together provide a dimensional signature of each antecedent stored in the data structure.

At 604, the antecedent is scaled. In order to solve a GSCS instance shown in equation (11), an approximating MIPS instance may be defined that results in a set of candidate association rules, which can potentially contain the association rule which is optimal for the GSCS problem. Such MIPS instance may be defined, shown in equation (16) based on equations (11)-(14), which may be scaled by 1/∥pᵢ∥₁ to replace hard constraints such as antecedent weights related to the subset containment with a proxy that prefers antecedents with larger lengths.

$$M I P S instance \text{:} {max}_{i ∈ D} \frac{f ( i )}{{‖ {p}_{i} ‖}_{1}} \cdot {\sum }_{j = 1}^{\vert {𝒯}_{\sim} \vert} {𝒥}^{j} \cdot {p}_{i}^{j} \qquad ( 16 )$$

If the MIPS instance of equation (16) may provide a maximum inner product of between two real vectors for providing an optimal solution for the GSCS instance, then the first vector is

$$\frac{f ( i )}{{‖ {p}_{i} ‖}_{1}} {p}_{i}$$

with j=1. This vector can be further scaled with a constant, i.e.,

$${max}_{i ∈ D} f ( i ) ,$$

without any impact on the optimal solution. Since 1≤i≤D and ∥pᵢ∥₁≤| [symbol] |, the antecedents of association rules may be scaled by a ratio, shown in equation (17), of the ordering function to a product of a least absolute deviation of the antecedent and a maximum value of the ordering function.

$${p}_{i}^{′} = \frac{f ( i )}{{‖ {p}_{i} ‖}_{1} {f}_{max}} {p}_{i} \qquad ( 17 )$$

where

pᵢ=antecedent

pᵢ′=scaled antecedent, pᵢ′∈

[symbol]

∥pᵢ∥₁=least absolute deviation of the antecedent

ƒ(i)=ordering function

$${f}_{max} = {max}_{i ∈ D} f ( i )$$

Such scaling ensures that ∥pᵢ∥₂≤1 and pᵢ′ in the MIPS instance has the same effect as using

$$\frac{f ( i )}{{‖ {p}_{i} ‖}_{1}} {p}_{i}$$

The ratio

$$\frac{f ( i )}{{‖ {p}_{i} ‖}_{1} {f}_{max}}$$

may compensate for the predefined weight of the association rule.

At 606, a first hash function and a second hash function are selected from a predetermined family of hash functions that are parameterized by spherical Gaussian vectors. In one embodiment, the rule fetch module 510 uses hash functions parameterized by Gaussian parameters to construct a data structure for faster retrieval. One example of such hash function is defined in equation (18).

hₐ(x)=sign(a^{T}x) (18)

where:

hₐ(x)=hash function a˜ [symbol] (0,1)

sign( )=scalar function

The scalar function of equation (18) outputs a value based on its argument. For example, the scalar function may return a positive unity value if its argument is positive, else may return a zero value. The output of the scalar function may be further hashed by a second hash function for a vector x, for example, an antecedent and more specifically, the scaled antecedent defined in equation (17). The rule fetch module 510 is further configured with another hash function, i.e., the second hash function, which may be a mapping function P, for example, as defined in equation (19).

P(x)=[x;\sqrt{1−∥x∥₂²}]∈ [symbol] (19)

where

x∈{x∈ [symbol] : ∥x∥₂≤1}

For any scaled antecedent vector, pᵢ′, ∥P(pᵢ′)∥₂ is equal to one based on ∥pᵢ∥₂≤1 and satisfy a property defined in equation (20).

$${P ( {p}_{i}^{′} )}^{T} P ( {𝒥}^{′} ) = {max}_{i ∈ D} ( \frac{f ( i )}{{‖ {p}_{i} ‖}_{1}} ) \cdot {\sum }_{j = 1}^{\vert {𝒯}_{\sim} \vert} {𝒥}^{′ j} \cdot {p}_{i}^{j} \qquad ( 20 )$$

where

$${𝒥}^{′} = \frac{1}{{‖ 𝒥 ‖}_{2}} 𝒥 = scaled version of the query transaction 𝒥$$

( )^{T}=Transpose operation

The second hash function of equation (19) may generate a hash table index based on the scaled antecedent pᵢ′ being mapped to the value returned by the first hash function hₐ(x), where x is the scaled antecedent pᵢ′. Each of the first and the second hash functions may be stored in the device database 508 for future access.

At 608, a data structure is created using the first hash function and the second hash function for storing the at least one association rule based on the hash table index. A dimensional signature of the antecedent of the at least one association rule is represented by a product of the predefined hashing concentration parameter and the predefined hashing repetition parameter.

Further, given the query transaction [symbol] , the rule fetch module 510 implements the Approx-GSCS-Query step to obtain a set of candidates that are possibly the top association rules. The Approx-GSCS-Query step is discussed with respect to a method 650, which may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 650 is described is not intended to be construed as a limitation, and any number of the described method blocks may be combined or otherwise performed in any order to implement the method 650 or an alternate method. Additionally, individual blocks may be deleted from the method 650 without departing from the spirit and scope of the present disclosure described herein. Furthermore, the method 650 may be implemented in any suitable hardware, software, firmware, or combination thereof, that exists in the related art or that is later developed.

At 652, a query transaction and a data structure storing a set of one or more association rules are received. In one embodiment, the rule fetch module 510 receives a query transaction and a data structure including association rules, each having a respective antecedent being scaled by a ratio of the ordering function to a product of a least absolute deviation of the antecedent and a maximum value of the ordering function. The data structure may be created by the Approx-GSCS-Prep step of the approximate rule fetch method discussed above with reference to the method 650.

At 654, dimensional signatures of the set of association rules are determined within the data structure based on the same hash functions that created the data structure. The rule fetch module 510 retrieves the first hash function and the second hash function discussed above in equations (18) and (19), respectively, from the device database 508 used for pᵢ′ vectors. The retrieved hash functions are used to determine dimensional signatures of the association rules. A dimensional signature refers to a location of an association rule within the data structure. Each dimensional signature may be defined by a product of values of an array of length defined by a hashing concentration parameter K and another array of length defined by a hashing repetition parameter L. Appropriate values of K and L, which may not depend on the number of rules D, may allow to retrieve the potentially top association rule candidates in a sub-linear time.

At 656, the set of one or more association rules is identified at the respective determined dimensional signatures. Once the dimensional signatures are determined, the rule fetch module 510 identifies corresponding association rule candidates within the data structure.

At 658, one or more association rules are retrieved from the set if the antecedent is a subset of a query transaction. The rule fetch module 510 retrieves the identified association rule if an antecedent of that rule is a subset of the query transaction [symbol] based on equation (12) or else prune the association rule. After such pruning, the rule fetch module 510 runs into either of two cases, namely, (a) no association rule is left, and (b) few association rules are left, for retrieval. The rule fetch module 510 outputs one or more predefined baseline rules in case of (a), and sort association rules in case of (b). One example of a predefined baseline rule may include an association rule whose antecedent is NULL, which may mean that any item may behave as a legitimate antecedent, and the consequent is a finite list of globally popular items. Such association rule may recommend items that are globally popular when the rule fetch module 510 is unable to filter applicable rules based on the query transaction [symbol] .

At 660, the retrieved one or more association rules are sorted. In one embodiment, the rule fetch module 510 sorts the retrieved, i.e., unpruned, association rules based on a predefined ordering function in a decreasing order of lengths of the antecedents associated with one or more association rules to generate a sorted list. Examples of the ordering function may include such as those discussed above. In case of two or more association rules having the same antecedent lengths, the ordering function is preconfigured or dynamically configured to select the top association rule in the sorted list of association rules. The selected top association rule is then outputted by the rule fetch module 510 at 662.

### Exact Rule Fetch Method

The rule fetch module 510 is preconfigured or dynamically configured to selectively employ the exact rule fetch method, hereinafter referred to as exact method, for selection and retrieval of association rules from the database 110 on the server 102. In one embodiment, the exact method involves a preprocessing phase and a query answering phase. In the preprocessing phase, the exact method allows to create a novel two-level data structure (TLDS) for storing and retrieving high dimensional data such as strings. The two-level data structure may store association rules along with respective rule attributes such as weights. In the query answering phase, the client device 104 may preprocess a query before querying the server 102, which may answer the query using the two-level data structure. The query refers to a string including or being a combination of text, numeric characters, alphanumeric characters, symbolic characters, graphics objects, and so on.

The two-level data structure may advantageously allow the server 102 to efficiently and privately respond to a query from the client device 104. Such private response may refer to a property of the two-level data structure that enables the client device 104 to quickly verify existence of the query, for example, an antecedent of an association rule, in the database 110 while revealing limited information about the query to the server 102. For example, the client device 104 may be enabled to fetch data associated with the query without an underlying string of the query being revealed to the server 102. Simultaneously, the two-level data structure may enable the server 102 to reveal minimum information about its database 110 to the client device 104. The two-level data structure is efficient in terms of overall communication complexity, round complexity as well as computations done by the server 102. The two-level data structure is symmetric, efficient, and imposes a reasonable degree of data privacy. Being symmetric refers to the two-level data structure using a single hash function for hashing all elements at a first level and another hash function for hashing all elements at a second level.

The two-level data structure may be discussed with respect to an exemplary method 700, which may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 700 is described is not intended to be construed as a limitation, and any number of the described method blocks may be combined or otherwise performed in any order to implement the method 700 or an alternate method. Additionally, individual blocks may be deleted from the method 700 without departing from the spirit and scope of the present disclosure described herein. Furthermore, the method 700 may be implemented in any suitable hardware, software, firmware, or combination thereof, that exists in the related art or that is later developed.

At 702, a database storing association rules is received. The rule fetch module 510 may receive or access a complete database such as the database 110 including or storing the association rules on the server 102. In some embodiments, the rule fetch module 510 may remotely access the database 110 of strings on the server 102, where each string may be an antecedent of an association rule as shown in equation (21).

D⊂Σ* (21)

where

D=Database of strings (e.g., antecedents)

Σ*=Set of sequences over Σ

In equation (21), Σ may refer to a non-empty finite set of symbols, which in one embodiment may be called as alphabets, such that each symbol is a string (e.g., word) over Σ and may be any finite sequence of symbols from Σ. The association rule includes the antecedent that implies an associated consequent. Similar to the antecedent, the consequent may be a string including a sequence of, but not limited to, text, numeric characters, alphanumeric characters, symbolic characters, graphics objects, or any combination thereof.

At 704, a domain and size range are defined. The rule fetch module 510 predefines or dynamically defines a domain, i.e., an input, based on the association rules for being hashed. In one embodiment, the rule fetch module 510 concatenates an antecedent of each association rule with an arbitrary vector to generate the domain x^{o} as defined in equation (22). In the present context, each domain may represent an association rule.

x^{o}=r′∘x (22)

where

r′=arbitrary vector

∘=concatenation operator

x=antecedent of an association rule, x∈D

D=Database

The rule fetch module 510 randomly selects the arbitrary vector, whose size may be predefined or dynamically defined based on a user input. The arbitrary vector refers to a predefined string whose selection by the rule fetch module 510 may be inconsequential. The arbitrary vector may be randomly generated or deterministically generated by the rule fetch module 510. One example of the arbitrary vector is shown in equation (23a).

r′∈{0,1}^{l} (23a)

where

l=size of the arbitrary vector

Similar to the arbitrary vector, the rule fetch module 510 predefines or dynamically defines a size for each element, hereinafter referred to as element size, of the two-level data structure based on a user input. Based on the selected element size, the rule fetch module 510 defines a maximum size of the two-level structure. In one example, when the element size is selected to be 4 bits, the rule fetch module 510 may define a maximum size, hereinafter referred to as TLDS-maximum size, of the two-level data structure as shown in equation (23b).

L=2^{r}·|D|=2⁴·|D|=16·|D| (23b)

where

L=maximum size of the two-level data structure

r=size (in bits) of each element in the two-level data structure

|D|=size of the database on server

According to the defined TLDS-maximum size for the two-level data structure, the rule fetch module 510 may pad each element, which may have a length shorter than the element size, for example, 4-bits, with a predefined character such as zero up to the element size. Such padded characters decrease a collision probability during hashing and maintain the universality of the selected hash function. Collision probability refers to a probability of finding a location, which is elected to store a new element, where the location is a non-empty location in the two-level data structure. Universality of a hash function refers to an ability of a hash function to maintain a predefined mathematical property for a logically consistent output despite of different inputs.

At 706, each association rule is encrypted based on a predefined cryptographic hash function. The rule fetch module 510 is preconfigured or dynamically configured with any of a variety of predefined cryptographic hash functions known in the art, related art, or developed later including an MD5 hash function. The rule fetch module 510 uses a selected cryptographic hash function to encrypt the defined domain to represent an encrypted association rule. The cryptographic hash function may convert each domain into a unique encrypted element based on the selected element size, as shown in equation (24a).

Cᵣ:Cᵣ(x^{o})⇒Cᵣ(r′∘x) (24a)

where

Cᵣ=Cryptographic hash function

Cᵣ: Σ^{MAX+l}→2^{r}

MAX=maximum size of each antecedent in the database D

l=size of the arbitrary vector

As shown in equation (24a), a size of each element, i.e., antecedent, in the non-empty finite set of symbols may increase from MAX to MAX+l due to an additional size l of the arbitrary vector for each domain. The size of each element may be then changed to selected element size r for being stored in the two-level data structure.

At 708, the encrypted association rule is hashed by a first hash function based on a predefined condition. The rule fetch module 510 selects a first hash function from a predetermined hash function family. For example, the rule fetch module 510 may select a random hash function, hᵣ, from a 2-Universal hash function family. The rule fetch module 510 uses the random hash function to perform a first level of hashing. In the first level, the rule fetch module 510 hashes the defined domains, which represent antecedents of the association rules, and generate hash values. Each hash value in the first level may represent an index of a bucket of a two-level data structure as shown in equation (24b).

hᵣ˜Uniform(H₂)

Bᵢ={x∈D:hᵣ(x^{o})=i} (24b)

where:

Bᵢ=number of hashed elements in the bucket i

hᵣ=first-level hash function (or first hash function)

x^{o}=r′∘x

In equation (24b), Uniform(H₂) indicates that the first hash function hᵣ is a uniform hash function selected from a predetermined family of hash functions, where the family is represented by H₂. According to the equation, each bucket may store a set of hash values corresponding to the domains, and hence the association rules until a maximum limit of the bucket is reached, where this maximum limit is defined by a predefined condition illustrated in equation (25).

Σᵢ₌₁^{L}bᵢ²≤4|D| (25)

where

b(i)→|Bᵢ|=length or size of the bucket

As shown in equation (25), each bucket stores one or more generated domains till the square of a size of each bucket is less than or equal to four times the size of the database 110 on the server 102. Each of such buckets together form a first level table A. The probability of the equation (25) being true may be more than half based on the same random hash function, i.e., the first hash function, being chosen to hash all the association rules in the first level.

At 710, the first-level hashed association rule is hashed by a second hash function to generate a second-level hashed association rule. In one embodiment, the rule fetch module 510 hashes each of the elements in the created buckets at a second level using a predefined second function, hₛ, which may be different from the first hash function. Such second level hashing using a different hash function from that used earlier, generates a unique hash value for each first-level hashed element as shown in equation (26).

hₛ˜Uniform(H₂) (26)

where

hₛ=second-level hash function (or second hash function)

hₛ:∀1≤i≤L and ∀x,y∈Bᵢ, hₛ(x)≠hₛ(y)

The probability of the second-level hashing to succeed based on equation (26) is more than or equal to ¾ based on the same random hash function, i.e., the second hash function, being chosen to hash all the association rules in the second level.

At 712, a two-level data structure is created based on the first hash function, the second hash function, and the predetermined maximum size for the two-level data structure. In one embodiment, the rule fetch module 510 organizes the second-level hashed values of the first-level hashed values to create the two-level data structure, where the location of each element, i.e., antecedent, is identified based on an index shown in equation (27).

H[L·hᵣ(x^{o})+hₛ(x^{o})]=x (27)

where

H=two-level data structure

H[i]=location of an antecedent x in H

i=L·hᵣ(x^{o})+hₛ(x^{o})=index

In equation (27), the antecedent x may be associated with a predefined association rule, which is retrieved by the rule fetch module 510 based on the index i. In some embodiment, the rule fetch module 510 may also retrieve attributes associated with the antecedent x and stored at the location H[i]. The retrieved attribute may be used by the client device 104 to verify the presence of a query such as the query transaction T, which may be a string, in the two-level data structure.

Once created, the rule fetch module 510 uses the two-level data structure to conduct a reasonably private search for the query. The process of querying the two-level data structure for an antecedent, which is a string, may be discussed with respect to an exemplary method 750, which may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 750 is described is not intended to be construed as a limitation, and any number of the described method blocks may be combined or otherwise performed in any order to implement the method 750 or an alternate method. Additionally, individual blocks may be deleted from the method 750 without departing from the spirit and scope of the present disclosure described herein. Furthermore, the method 750 may be implemented in any suitable hardware, software, firmware, or combination thereof, that exists in the related art or that is later developed.

At 752, a predefined vector, a first hash function, a second hash function, and a maximum size value used to create a two-level data structure are received. In one embodiment, a client device such as the client device 104 receives or accesses the database 110 on the server 102 to retrieve the predefined vector, the first hash function, the second hash function, and the maximum size value used to create a two-level data structure. The two-level data structure refers to a data structure that stores high dimensional data such as one or more association rules, which are symmetrically secured at two levels using hash functions for a reasonably private access to the data, discussed above. Each association rule includes an antecedent that implies a consequent, where both the antecedent and the consequent are strings. The two-level data structure may employ the first hash function and the second hash function, each being selected from the same family of hash functions such as 2-Universal hash function family to secure the high dimensional data. Each hash function may map data such as strings to unique values in a large domain of values. Further, the maximum size of the two-level data structure may be predefined based on the size of elements in a reference data structure storing the universal association rule set. For example, when the two-level data structure is made up of 4-bit elements, such as association rules, fetched from a private database such as the database 110 having a size D, then the maximum size of the two-level data structure may be equivalent to 16 D, as shown in equation (23b).

At 754, a string based on the predefined vector is preprocessed to generate a preprocessed string. In one embodiment, the client device 104 receives a string that needs to be searched in the two-level data structure. The string may be preprocessed for querying the two-level data structure. In order to preprocess, the client device 104 concatenates the string with a predefined arbitrary vector received from the database 110. Such concatenation provide a preprocessed string that belongs to a private domain for carrying out a reasonably private search of the string in the two-level data structure. The client device 104 hashes the preprocessed string using the first hash function and the second hash function to generate a first hash value and a second hash value, respectively.

At 756, an index is determined for the string based on the first hash value, the second hash value, the preprocessed string, and the maximum size of the two-level data structure. The client device 104 determines an index for the string, where the index may be indicative of the position of the string in the two-level data structure. The client device 104 determines the index being equivalent to a sum of the second hash value and a product of the first hash value and the maximum size of the two-level data structure, as shown in equation (27).

At 758, the two-level data structure is queried with the determined index and the string to search for the presence of the string in the two-level data structure. In one embodiment, the client device 104 queries the two-level data structure with the determined index and the string for a possible return of an entry at the determined index. Based on the query, the server 102 searches for the string at a position indicated by the index and accordingly sends a result to the client device 104.

At 760, an association rule is retrieved based on the querying if the string matches an antecedent associated with the association rule in the two-level data structure. In one embodiment, the server 102 searches for the string in the two-level data structure. The server 102 may search the position indicated by the index for the string being matched with an antecedent at that position. If there is a positive match, the server 102 may send a corresponding association rule associated with the antecedent that matched the string, to the client device 104. If there is no match, the server 102 may indicate “No Match” as well as return a null value to the client device 104.

The methods 700 and 750 indicate two key properties of the two-level data structure noted here as Lemma 1. First being a client device such as the client device 104 not learning about the existence or absence of any other element in the database 110 of the server 102, other than whether or not a query string x is an element of the database 110. The second property of the two-level data structure is that the two-level data structure allows the server 102 to learn only the hash values hᵣ(r′∘x) and hₛ(r′∘x) of the query string x, which may be an antecedent of the association rule in the database 110, and nothing more about the actual query string x.

The methods 700 and 750 may be used by the rule fetch module 510 to implement any of the predetermined criteria, namely, the top association criterion, the maximum association criterion, the all association criterion, and the any association criterion discussed above with reference to equations 4, 7, 8, and 9, respectively, for selecting relevant association rules.

For example, the methods 700 and 750 may be used to implement the top association criterion to fetch an exact association rule, hereinafter the corresponding method is referred to as Exact-TOP-Assoc rule fetch method, based on the exact rule fetch method discussed above with respect to the method 700. The Exact-TOP-Assoc rule fetch method may be discussed with respect to an exemplary method 800, which may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 800 is described is not intended to be construed as a limitation, and any number of the described method blocks may be combined or otherwise performed in any order to implement the method 800 or an alternate method. Additionally, individual blocks may be deleted from the method 800 without departing from the spirit and scope of the present disclosure described herein. Furthermore, the method 800 may be implemented in any suitable hardware, software, firmware, or combination thereof, that exists in the related art or that is later developed.

At 802, a transaction, a two-level data structure, a threshold weight, an antecedent length threshold, an output size parameter, and an ordering function are received. The rule fetch module 510 receives a transaction from the client device 104. The transaction may be a string that the client device 104 may require to search in a two-level data structure, which is discussed above. The rule fetch module 510 is also preconfigured or dynamically configured with various parameters including, but not limited to, a threshold weight, an antecedent length threshold, an output size parameter, and an ordering function. The ordering function may determine which of the association rules are the top k association rules, where a value of k may be equivalent to a value of the output size parameter.

Based on the configured parameters, the rule fetch module 510 retrieves a set of one or more association rules from the two-level data structure based on the transaction, at 804. For example, the rule fetch module 510 may search for an antecedent associated with each association rule in the two-level data structure for a possible match provided predefined conditions are fulfilled. Examples of these conditions may include, but not limited to, the antecedent being an element of the transaction, a length of the antecedent being less than or equal to the antecedent length threshold, a weight of the antecedent being less than or equal to the threshold weight, and so on. Subsequently, the rule fetch module 510 may sort the retrieved set of one or more association rules using any of the sorting techniques known in the art, related art, or developed later, at 806. From the sorted set of multiple association rules, the rule fetch module 510 may output a predefined number of association rules selected from the set, where the number is equivalent to a value of the output size parameter, at 808.

### Collate

Once a set of applicable association rules according to one of the criteria, discussed above, are generated, the rule fetch module 510 communicates these generated association rules to the recommendation module 512, which may compile a list of item recommendations based on either under an un-capacitated setting or an capacitated setting. Under the un-capacitated setting, the recommendation module 512 outputs a union of consequents associated with the association rules in the generated set. Each of the consequents represent an item that may be recommended to a user based on a received transaction or query transaction from the client device 104. Such setting of outputting the union of consequents may list a potentially large number of item recommendations, which the client device 104 may not be able to accommodate due to a capacity constraint on the number of items that the client device 104 can recommend to the user, as shown in equation 28.

k′<<| [symbol] | (28)

where

k′=number of recommended items that a client device can accommodate

| [symbol] |=size of a universal item set

<<=very less than

Under the capacitated setting, the recommendation module 512 accumulates weights associated with each item available for recommendation corresponding to a transaction or query transaction received from the client device 104. The recommendation module 512 adds up the computed weights of the applicable association rules to determine a total weight of the association rules. Subsequently, the recommendation module 512 sorts the applicable association rules according to these accumulated weights and create a sorted list of applicable association rules. In order to send a capacitated list of recommended items to the client device 104, the recommendation module 512 may send the top k′ items from this sorted list if a condition of equation (29) is true, else the recommendation module 512 may send all the recommended items to the client device 104.

k′<| [symbol] qₗ| (29)

where

[symbol] =a set of applicable association rules according to one of the criteria

qₗ=consequent associated with an association rule in the set [symbol] , 1<l<| [symbol] |

| [symbol] |=size of the set [symbol] or total number of association rules in the set

[symbol]

| [symbol] qₗ|=total size of consequents associated with association rules in the set

[symbol]

### Privacy Preserving Protocols

When a user selects or activates the private mode, the PPR device 108 implements any of the selected criteria, discussed above, either based on the approximate rule fetch method or the exact rule fetch method as privacy preserving protocols, defined in Definition 3.
Definition 3: When a server S has a database, such as the database 110, represented as a vector of elements represented as \vec{v}[1:n] and a client device C includes an input i∈[1, . . . , n], such that the client C needs to retrieve the i^{th} element from the server S, then a protocol that realizes this input/output specification is called secure iff the Property 1 and the Property 2 hold true.
Property 1: The ensembles View_{S}(S(\vec{v}), C(i)), View_{S}(S(\vec{v}), C(j)) are computationally indistinguishable for all pairs of elements i, j, where the random variable View_{S} may refer to the transcript of the server S created by execution of the protocol.

Property 2: There is a (probabilistic polynomial time) simulator Sim, such that for any query element c, Sim(c,\vec{v}[c]) and View_{c}(S(\vec{v}), C(c)) are computationally indistinguishable.

The protocol defined by Property 1 and Property 2 may be called as the oblivious transfer protocol, represented as OT[C: i,S: [1, . . . , n]], in which the client C retrieves i^{th} data point from the server S having n (≥i) data points. In one embodiment, the rule fetch module 510 may implement a fast and parallel implementation of the oblivious transfer protocol based on additive homo-morphic encryption and length preserving, which ensures that I-bit input is mapped to an input of size I+c, where c is a constant.

Further, the homo-morphic encryption with a public key pk of message m may be denoted as c=Eₚₖ(m) and decryption with a private key sk may be denoted as m=Dₛₖ(c). Any operation over the cypher text may also reflect on the decrypted plain text. For instance, let c₁ and c₂ be two cypher texts such that—

c₁=Eₚₖ(m₁) and c₂=Eₚₖ(m₁)

Then, c₁+c₂=Eₚₖ(m₁+m₂), where ‘+’ represents a binary operation

### Private Protocol for Answering if a String is an Element of the Database

The two-level data structure discussed above with reference to the method 700 is based on Lemma 1 (mentioned above), which implies that the privacy preservation of the client device 104 is limited. The index created by the client device 104, as discussed above with reference to equation (27), i.e., i=L·hᵣ(x^{o})+hₛ(x^{o}), can be rewritten as shown in equation (30) for an array H which may represent an instance of oblivious transfer.

index=|D|·hᵣ(str∘r′)+hₛ(str∘r′) (30)

where

r′=arbitrary vector

∘=concatenation operator

str=transaction received from the client device

D=Database

The execution of the OT protocol defined in Definition 3 between the client C and the server S allows to privately fetch the Cᵣ-hash of string str∘r′ in equation (30)., and may be stored in a record H[|D|·hᵣ(str∘r′)+hₛ(str∘r′)]. Cᵣ( ). Thus, the choice of using Cᵣ-hash leads to a guarantee that there exists a two way protocol in which (1) the client C learns whether str∈D with very high probability given the description of associated hash functions hᵣ, hₛ, and (2) the computationally bounded server S learns nothing.

In order for the PPR device 108 to hide the descriptions of the hash functions hᵣ, hₛ, the client device 104 encrypts the corresponding strings strᵣ=str(mod r), strₛ=str(mod s), which may correspond to query transactions, using appropriately chosen additively homo-morphic encryption key and may send it to the rule fetch module 510. The rule fetch module 510 then computes encryption of aᵣ·strᵣ+bᵣ−pᵣ·r and aₛ·strₛ+bₛ−pₛ·s from the received encrypted values for randomly chosen parameters pᵣ, pₛ within an appropriate range. The rule fetch module 510 sends these encrypted values to the client device 104, which may extract the respective values at its end to obtain the respective indexes, and then fetch the final value by executing the OT protocol of Definition 3 with the rule fetch module 510.

### Private Protocols Between the PPR Device and a Client Device

The private protocol for collating the recommended items that may be implemented between the PPR device 108 and the client device 104 are discussed below. The private protocol implemented on the PPR device 108 for oblivious transfer of data may be discussed with respect to an exemplary method 850, which may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 850 is described is not intended to be construed as a limitation, and any number of the described method blocks may be combined or otherwise performed in any order to implement the method 850 or an alternate method. Additionally, individual blocks may be deleted from the method 850 without departing from the spirit and scope of the present disclosure described herein. Furthermore, the method 850 may be implemented in any suitable hardware, software, firmware, or combination thereof, that exists in the related art or that is later developed.

At 852, an anonymized transaction and predefined public identifiers are received from a client device 104. In one embodiment, the rule fetch module 510 receives an anonymized transaction as a query and predefined public identifiers from the client device 104. The anonymized transaction may include one or more strings, for example, items, each being represented by a corresponding predefined public identifier.

At 854, frequent items and non-frequent items in a universal item set are identified based on a predetermined frequency associated with each item in the universal item set. In one embodiment, the rule fetch module 510 maintains an item frequency table in the device database 508 for each item in the universal item set. The item frequency table may include an occurrence frequency of each item based on the number of times an item is received in a query transaction such as the anonymized transaction from the client device 104. The rule fetch module 510 checks the frequency of each item against a predefined threshold frequency to identify whether or not that is a frequent item. For example, the rule fetch module 510 may identify an item as a frequent item if it has the occurrence frequency greater than or equal to the predefined threshold frequency, else the item may be identified as a non-frequent item.

At 856, the frequent items are mapped as the corresponding predefined public identifiers and the non-frequent items are mapped as zero in a table. In one embodiment, the rule fetch module 510 maps the identified frequent items in the frequency table and represent them as their corresponding predefined public identifiers. On the other hand, the rule fetch module 510 represents the non-frequent items as zero in the frequency table. A list of predefined public identifiers for items in the universal item set may be received from the client device 104 or fetched from the server database 110, where the client device 104 may have stored these public identifiers.

At 858, a list of recommended items is retrieved from the frequency table for the plurality of items based on the predefined public identifiers using a predefined rule fetch criterion. In one embodiment, the rule fetch module 510 employs any of the predefined rule fetch criteria, discussed above, which may identify relevant association rules by matching the items of the anonymized transaction with antecedent of the association rules based on the predefined public identifiers. The rule fetch criteria may be implemented using the approximate rule fetch method or the exact rule fetch method, as discussed above. Once the applicable association rules that are relevant to the anonymized transaction are identified, the recommendation module 512 uses these applicable association rules to retrieve a list of recommended items, which are consequents of the applicable association rules.

At 860, the retrieved list of recommended items is privately collated based on associated weights. In one embodiment, the recommendation module 512 collates the retrieved list of recommended items based on their associated weights. For example, the recommendation module 512 may use any of the oblivious sorting techniques known in the art, related art, or developed later to sort the retrieved list based on the weights of the recommended items in the list. The recommendation module 512 also encrypts the weights using any encryption techniques known in the art, related art, or developed later, including homo-morphic encryption.

Similar to the method 850, the private protocol may be implemented on the client device 104 for oblivious transfer of data to the server 102 and is discussed with respect to an exemplary method 900, which may be described in the general context of computer-executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method 900 is described is not intended to be construed as a limitation, and any number of the described method blocks may be combined or otherwise performed in any order to implement the method 900 or an alternate method. Additionally, individual blocks may be deleted from the method 900 without departing from the spirit and scope of the present disclosure described herein. Furthermore, the method 900 may be implemented in any suitable hardware, software, firmware, or combination thereof, that exists in the related art or that is later developed.

At 902, a transaction including one or more items is anonymized. In one embodiment, the client device 104 anonymizes a transaction including one or more items being used to retrieve a set of recommended items. In order to anonymize, the client device 104 represents each item in the transaction by a predefined public identifier, which may be sent to the PPR device 108 for retrieving a list of recommended items.

At 904, a set of anonymized recommended items is received based on the anonymized transaction. The client device 104 receives a list of anonymized recommended items from the PPR device 108 based on the anonymized transaction. Each recommended item may be anonymized by the PPR device 108 by representing the recommended item by the predefined public identifier generated by the client device 104.

At 906, the set of anonymized recommended items is deanonymized using the predefined public identifier. In one embodiment, the client device 104 includes an identifier table of predefined public identifiers that may be generated for each item in the universal item set. When the set of anonymized recommended items is received, the client device 104 actually fetches the actual public identifiers from the identifier table and reverse map to know the true identities, i.e., names, of the recommended items. Such reverse mapping based on the predefined public identifiers may be termed as deanonymizing the recommended items.

### Private Protocol for the Approximate Rule Fetch Method

Under the private mode, in one embodiment, the rule fetch module 510 implements a privacy preserving protocol into the methods 600 and 650. As discussed in the description of method 700, the rule fetch module 510 chooses l random maps where the i^{th} map funcᵢ, maps a set T⊂I represented as a characteristic vector v_{T}, of length |I|, where I denotes a set of frequent items, to a string Tᵢ of k bits, as discussed above. Thus, each antecedent p, of association rule p→q, is mapped to l strings p₁, p₂, . . . , pᵢ, . . . , pₗ of length k bits each. For an input transaction T or a query transaction received from the client device 104, an association rule p→q may be selected by the rule fetch module 510 iff any of the i maps, funcᵢ(v_{T}) exactly matches funcᵢ(p).

### Pre-Processing the Database D Under the Approximate Method

Let the maps funcⱼ, for j={1, . . . , l}, be defined with reference to the method 600 and let the association rules be enumerated as P₁, P₂, . . . , Pᵢ, . . . , P_{|D|}, where Pᵢ=pᵢ→qᵢ. In one embodiment, the rule fetch module 510 creates an enhanced database of association rules D. In order to create the enhanced database, the rule fetch module 510 selects l random strings r₁, r₂, r₃, . . . , rₗ∈{0,1}^{s}, where s is a security parameter that may refer to an arbitrary length of these strings. The security parameters may be a positive number, for example, 10, 100, 5, 13, etc., which may assist to generate arbitrary length strings independent of any of the parameters while increasing the performance of the private protocols, discussed above. The j^{th} map for the i^{th} association rule outputs funcᵢ(pᵢ). The rule fetch module 510 creates the enhanced database Dₑ from the server database by respectively concatenating the above random strings to the l-maps, i.e., r₁∘func₁(pᵢ), r₂∘func₂(pᵢ), . . . , rⱼ∘funcⱼ(pᵢ), . . . , rₗ∘funcₗ(pᵢ), for each association rule, i∈[|D|]. The enhanced database Dₑ has l·|D| elements, each of which may store all relevant information for the association rule. All strings rᵢ∘func₁(pᵢ), along with corresponding consequents qᵢ, and any other information, in the enhanced database Dₑ may also be entered into the two-level data structure discussed above.

### Pre-Processing a Query Under the Approximate Method

The client device 104 obtains the definition of the l maps, funcᵢ, i∈{1, . . . , l}, along with random prefixes or strings rᵢ, discussed above, which may be declared (e.g., on web-pages) and available publicly. The client device 104 applies the l maps on the characteristic vector v_{T}, corresponding to its input transaction T or query transaction, and may obtain the values of funcᵢ(v_{T}), from which the rule fetch module 510 may prepare rᵢ∘funcᵢ(v_{T}) for i∈{1, . . . l}.

### Privately Receiving Answers to the Query Under the Approximate Method

The client device 104 queries the server 102 via the PPR device 108 for existence of each string rᵢ∘funcᵢ(v_{T}), for i={1, 2, 3, . . . , l}, with the PPR device 108 possessing the data structure discussed above in the description of the method 850 using any of the predefined approaches. In a first example, the rule fetch module 510 may execute the method of 800, in which the rule fetch module 510 may reveal the values of hᵣ(rᵢ∘funcᵢ(v_{T})) and hₛ(rᵢ∘funcᵢ(v_{T})), for i∈{1, 2, . . . , l} to the server 102. In a second example, the rule fetch module 510 may execute the methods of 850 and 900, in which case the rule fetch module 510 may guarantee privacy, i.e., the rule fetch module 510 may give away only descriptions of hash functions hᵣ and hₛ. Similar to the approximate rule fetch method, the rule fetch module 510, or the PPR device 108, may embed a private protocol to the exact rule fetch method discussed above in the description of methods 700, 750, and 800.

Once the recommended items are collated, the recommendation module 512 sends them to the client device 104 for display or store them in a repository for later use or reference. Unlike the traditional privacy preserving techniques that involved data modification or noise addition, the novel privacy preserving technique implemented by the PPR device 108 provides efficient privacy solution based on cryptography and use the framework of association rules.

The order in which all of the above methods are described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating,” or “monitoring,” or “displaying,” or “tracking,” or “identifying,” or “receiving,” or “recommending,” or “determining,” or “collating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-implemented method for privacy preserving recommendation of items based on association rules, each being represented as an antecedent that implies a consequent, the method comprising:
receiving a transaction indicated by a query from a client device, wherein the transaction includes a plurality of items selected by a user;
identifying one or more association rules applicable to the received transaction from a data structure storing a universal association rule set provided the one or more association rules include antecedents that are a subset of the transaction, wherein the one or more association rules are identified based on one of a plurality of predefined criteria implemented using a predetermined rule fetch method;
determining consequents associated with the identified one or more association rules, wherein each of the consequents include at least one item;
collating a set of items based on the determined consequents, wherein the collated set of items are sorted based on a predefined attribute associated with each item in the set; and
recommending a list of one or more items from the collated set to the client device, wherein a number of items in the list is based on a receiving capacity of the client device.

2. The computer-implemented method of claim 1, wherein the plurality of items is anonymized based on a set of predefined public identifiers generated by the client device.

3. The computer-implemented method of claim 2, wherein the recommended list of one or more items is anonymized using the same set of predefined public identifiers generated by the client device.

4. The computer-implemented method of claim 1, wherein the plurality of items includes frequent items having a frequency of being selected by the user greater than or equal to a predefined frequency threshold.

5. The computer-implemented method of claim 1, wherein the plurality of predefined criteria are differentiated based on predefined parameters including at least one of an antecedent weight threshold, an antecedent length threshold, a predefined count of maximum number of applicable association rules, and a rule ordering function.

6. The computer-implemented method of claim 1, wherein the predefined attribute is an antecedent weight.

7. The computer-implemented method of claim 1, wherein the predefined rule fetch method includes at least one of an approximate method and an exact method.

8. The computer-implemented method of claim 7, wherein the approximate method creates the data structure based on an antecedent associated with each association rule in the universal association rule set being scaled by a ratio of an ordering function to a product of a least absolute deviation of the antecedent and a maximum value of the ordering function.

9. The computer-implemented method of claim 8, wherein the data structure is a hash table including the scaled antecedent being hashed using at least one predefined hash function.

10. The computer-implemented method of claim 8, wherein the scaled antecedent is concatenated with a random string to generate a concatenated string.

11. The computer-implemented method of claim 10, wherein the data structure is queried by the client device using the concatenated string.

12. The computer-implemented method of claim 1, wherein the exact method creates the data structure as a two-level data structure that symmetrically secures the universal association rule set at two different levels, wherein the two-level data structure includes each association rule in the universal association rule set being hashed by a first hash function at a first level to generate a first hash value, which is again hashed by a second hash function at a second level to generate a second hash value.

13. The computer-implemented method of claim 12, wherein the first hash function and the second hash function belong to the same family of hash functions.

14. The computer-implemented method of claim 12, wherein the first hash value is different from the second hash value for each association rule in the universal association rule set.

15. The computer-implemented method of claim 12, wherein the each association rule is concatenated with a random vector to generate a concatenated input for the first hash function.

16. The computer-implemented method of claim 12, wherein the two-level data structure is queried by the client device using an index based on the first hash function, the second hash function, and a maximum size of the two-level data structure.

17. A device for privacy preserving recommendation of items based on association rules, each being represented as an antecedent that implies a consequent, the device comprising:
a rule fetch module configured to:
receive a transaction indicated by a query from a client device, wherein the transaction includes a plurality of items selected by a user;
identify one or more association rules applicable to the received transaction from a data structure storing a universal association rule set provided the one or more association rules include antecedents that are a subset of the transaction, wherein the one or more association rules are identified based on one of a plurality of predefined criteria implemented using a predetermined rule fetch method; and
determine consequents associated with the identified one or more association rules, wherein each of the consequents include at least one item; and
a recommendation module configured to:
collate a set of items based on the determined consequents, wherein the collated set of items are sorted based on a predefined attribute associated with each item in the set; and
recommend a list of one or more items from the collated set to the client device, wherein a number of items in the list is based on a receiving capacity of the client device.

18. The device of claim 17, wherein the plurality of items is anonymized based on a set of predefined public identifiers generated by the client device.

19. The device of claim 18, wherein the recommended list of one or more items is anonymized using the same set of predefined public identifiers generated by the client device.

20. The device of claim 17, wherein the plurality of items includes frequent items having a frequency of being selected by the user greater than or equal to a predefined frequency threshold.

21. The device of claim 17, wherein the plurality of predefined criteria are differentiated based on predefined parameters including an antecedent weight threshold, an antecedent length threshold, a predefined count of maximum number of applicable association rules, and a rule ordering function.

22. The device of claim 17, wherein the predefined attribute is an antecedent weight.

23. The device of claim 17, wherein the predefined rule fetch method includes at least one of an approximate method and an exact method.

24. The device of claim 23, wherein the rule fetch module is further configured to implement the approximate method for creating the data structure based on an antecedent associated with each association rule in the universal association rule set being scaled by a ratio of an ordering function to a product of a least absolute deviation of the antecedent and a maximum value of the ordering function.

25. The device of claim 24, wherein the data structure is a hash table including the scaled antecedent being hashed using at least one predefined hash function.

26. The device of claim 24, wherein the scaled antecedent is concatenated with a random string to generate a concatenated string.

27. The device of claim 26, wherein the data structure is queried by the client device using the concatenated string.

28. The device of claim 17, wherein the rule fetch module is further configured to implement the exact method for creating the data structure as a two-level data structure that symmetrically secures the universal association rule set at two different levels, wherein the two-level data structure includes each association rule in the universal association rule set being hashed by a first hash function at a first level to generate a first hash value, which is again hashed by a second hash function at a second level to generate a second hash value.

29. The device of claim 28, wherein the first hash function and the second hash function belong to the same family of hash functions.

30. The device of claim 28, wherein the first hash value is different from the second hash value for each association rule in the universal association rule set.

31. The device of claim 28, wherein the each association rule is concatenated with a random vector to generate a concatenated input for the first hash function.

32. The device of claim 28, wherein the two-level data structure is queried by the client device using an index based on the first hash function, the second hash function, and a maximum size of the two-level data structure.

33. A non-transitory computer-readable medium comprising computer-executable instructions for privacy preserving recommendation of items based on association rules, each being represented as an antecedent that implies a consequent, the non-transitory computer-readable medium comprising instructions for:
receiving a transaction indicated by a query from a client device, wherein the transaction includes a plurality of items selected by a user;
identifying one or more association rules applicable to the received transaction from a data structure storing a universal association rule set provided the one or more association rules include antecedents that are a subset of the transaction, wherein the one or more association rules are identified based on one of a plurality of predefined criteria implemented using a predetermined rule fetch method;
determining consequents associated with the identified one or more association rules, wherein each of the consequents include at least one item;
collating a set of items based on the determined consequents, wherein the collated set of items are sorted based on a predefined attribute associated with each item in the set; and
recommending a list of one or more items from the collated set to the client device, wherein a number of items in the list is based on a receiving capacity of the client device.

34. The non-transitory computer-readable medium of claim 33, wherein the plurality of items is anonymized based on a set of predefined public identifiers generated by the client device.

35. The non-transitory computer-readable medium of claim 34, wherein the recommended list of one or more items is anonymized using the same set of predefined public identifiers generated by the client device.

36. The non-transitory computer-readable medium of claim 33, wherein the plurality of items includes frequent items having a frequency of being selected by the user greater than or equal to a predefined frequency threshold.

37. The non-transitory computer-readable medium of claim 33, wherein the plurality of predefined criteria are differentiated based on predefined parameters including an antecedent weight threshold, an antecedent length threshold, a predefined count of maximum number of applicable association rules, and a rule ordering function, or any combination thereof.

38. The non-transitory computer-readable medium of claim 33, wherein the predefined attribute is an antecedent weight.

39. The non-transitory computer-readable medium of claim 33, wherein the predefined rule fetch method includes at least one of an approximate method and an exact method.

40. The non-transitory computer-readable medium of claim 39, wherein the approximate method creates the data structure based on an antecedent associated with each association rule in the universal association rule set being scaled by a ratio of an ordering function to a product of a least absolute deviation of the antecedent and a maximum value of the ordering function.

41. The non-transitory computer-readable medium of claim 40, wherein the data structure is a hash table including the scaled antecedent being hashed using at least one predefined hash function.

42. The non-transitory computer-readable medium of claim 40, wherein the scaled antecedent is concatenated with a random string to generate a concatenated string.

43. The non-transitory computer-readable medium of claim 42, wherein the data structure is queried by the client device using the concatenated string.

44. The non-transitory computer-readable medium of claim 33, wherein the exact method creates the data structure as a two-level data structure that symmetrically secures the universal association rule set at two different levels, wherein the two-level data structure includes each association rule in the universal association rule set being hashed by a first hash function at a first level to generate a first hash value, which is again hashed by a second hash function at a second level to generate a second hash value.

45. The non-transitory computer-readable medium of claim 44, wherein the first hash function and the second hash function belong to the same family of hash functions.

46. The non-transitory computer-readable medium of claim 44, wherein the first hash value is different from the second hash value for each association rule in the universal association rule set.

47. The non-transitory computer-readable medium of claim 44, wherein the each association rule is concatenated with a random vector to generate a concatenated input for the first hash function.

48. The non-transitory computer-readable medium of claim 44, wherein the two-level data structure is queried by the client device using an index based on the first hash function, the second hash function, and a maximum size of the two-level data structure.
